(19) United States
(12) Patent Application Publication
(10) Pub. No.: US 2016/0344055 A1
(43) Pub. Date: Nov. 24, 2016

(54) COMPOSITIONS COMPRISING AN OXIDIZER AND WATER, COMPOSITIONS COMPRISING BIOMASS, A BIOMASS-OXIDIZER, AND WATER, AND METHODS OF MAKING AND USING THE SAME

(71) Applicant: GEORGIA TECH RESEARCH CORPORATION, Atlanta, GA (US)

(72) Inventors: Yulin DENG, Atlanta, GA (US); Wei LIU, Atlanta, GA (US); Wei MU, Atlanta, GA (US)

(21) Appl. No.: 15/112,033

(22) PCT Filed: Jan. 17, 2015
(86) PCT No.: PCT/US2015/011881

§ 371 Date: Jul. 15, 2016

Related U.S. Application Data
(60) Provisional application No. 61/928,760, filed on Jan. 17, 2014.
(60) Provisional application No. 62/051,443, filed on Sep. 17, 2014.

(51) Int. Cl. H01M 8/16; H01M 8/04858; H01M 8/04082; H01M 8/1018; H01M 8/0234

(52) U.S. Cl. CPC H01M 8/16; H01M 8/1018; H01M 8/0234; H01M 8/04201; H01M 8/04858

(57) ABSTRACT

Disclosed herein are compositions comprising an oxidizer, water, and optionally a neutralizer, and methods of making and using the same. Also disclosed herein are compositions comprising biomass, a biomass-oxidizer, water, and optionally an accelerant, and methods of making and using the same.

### CROSS-REFERENCE TO RELATED APPLICATIONS

This application claims priority to U.S. Provisional Patent Application No. 61/928,760, filed Jan. 17, 2014, titled “Solar- or Heat-Induced Direct Fuel Cell Using Polyoxometalate as Photo-Catalyst and Charge Carrier,” and to U.S. Provisional Patent Application No. 62/051,443, filed Sep. 17, 2014, titled “High Performance Low Temperature Direct Biomass Fuel Cells with Two Liquid Regenerable Polyoxometalate Solutions,” both of which are incorporated herein by reference in their entirety.

### TECHNICAL FIELD

This disclosure relates to compositions comprising an oxidizer, water, and optionally a neutralizer, and methods of making and using the same. This disclosure also relates to compositions comprising biomass, a biomass-oxidizer, water, and optionally an accelerant, and methods of making and using the same.

### BACKGROUND

With the depletion of fossil energy and growing environmental concerns, developing renewable energy sources becomes more and more important. Today, fossil fuels still dominate the energy market, accounting for over 80% of global energy consumption. Producing electricity to power our world from sustainable energy sources (e.g., solar energy and biomass) can reduce the dependence on fossil fuels.

Fuel cells are one option for power generation with high-energy yield and low environmental impact. Fuel cell technologies include, for instance, solid oxide fuel cells (SOFCs), microbial fuel cells (MFCs), and polymer exchange membrane fuel cells (PEMFCs). However, those technologies have a number of disadvantages. SOFCs can require very high working temperatures (e.g., 500° C. to 1000° C.) to gassify biomass. MFCs can work at low temperatures, but very low electric power output, rigorous reaction conditions, and limited lifetime can seriously hinder their applications. PEMFCs can require expensive surface catalysts on the fuel cell anode that cannot withstand even trace amounts of impurities. Therefore, the fuel purification process for PEMFCs can add additional cost. Additionally, PEMFCs cannot be used to convert biomass to electricity, because the carbon-to-carbon (C—C) bonds in the biomass cannot be completely electro-oxidized to CO₂ at low temperatures, even with the expensive surface catalyst. Accordingly, improved methods and apparatuses to, for instance, produce electricity from sustainable energy sources are desirable.

### SUMMARY

Disclosed herein are a variety of compositions including, but not limited to, (1) compositions comprising an oxidizer, water, and optionally a neutralizer, and (2) compositions comprising biomass, a biomass-oxidizer, water, and optionally a accelerant. In some embodiments, the compositions comprising an oxidizer, water, and optionally a neutralizer can be used on the cathode-side of a fuel cell. In some embodiments, the compositions comprising biomass, a biomass-oxidizer, water, and optionally an accelerant can be used on the anode-side of a fuel cell. Fuel cells comprising those compositions are also disclosed herein. Some of the compositions disclosed herein can also be used to extract lipids from algae, and compositions, methods, and apparatuses relating thereto are also disclosed herein.

Disclosed herein is a cathode-side composition comprising an oxidizer comprising a polyoxometalate (POM) and water. In some embodiments, the polyoxometalate is selected from the group consisting of phosphomolybdic acid (PMo₁₂O₄₀), phosphotungistic acid (PW₁₂O₄₀), vanadium-substituted phosphomolybdic acid (PMo₉V₃O₄₀), addenda keggin type polyoxometalate (H₃PW₁₁MoO₄₀), and mixtures thereof. The cathode-side compositions can comprise an oxidizer, a neutralizer, water, and a reaction product of the oxidizer and the neutralizer. In some embodiments, the neutralizer is selected from the group consisting of alkali metals, alkali earth elements, transition metal cations, organic cations, and mixtures thereof. In some embodiments, the composition comprises two moles or greater (e.g, 3 moles, 4 moles, 6 moles) of the neutralizer for each mole of the oxidizer. Cathode-side compositions are disclosed wherein the oxidizer is a polyoxometalate. In some embodiments, the oxidizer is present in the composition in an amount of from 1% to 70% (e.g., 5% to 10%) by weight of the composition. In some embodiments, the reaction product is a salt-substituted oxidizer. In some embodiments, the water is present in the composition in an amount of 1% to 99%, by weight of the composition. Methods of making and using the cathode-side compositions are also disclosed herein.

Also disclosed herein are anode-side compositions comprising biomass, a biomass-oxidizer, water, and a reaction product of the biomass and the biomass-oxidizer. In some embodiments, the biomass comprises organic matter. In some embodiments, the organic matter comprises wood, starch, lignin, cellulose, ascorbic acid, algae, wheat, protein, yeast, animal product, or a combination thereof. In some embodiments, the biomass has an average particle size of 15 nm to 10 cm. In some embodiments, the biomass is present in the composition in an amount of from 0.5% to 70% (e.g., 5% to 10%), by weight of the composition. In some embodiments, the biomass-oxidizer is adapted to oxidize the biomass when exposed to heat, light, or a combination thereof. In some embodiments, the biomass-oxidizer is adapted to oxidize the biomass at a faster rate when exposed to heat. In some embodiments, the biomass-oxidizer is adapted to oxidize the biomass at a faster rate when exposed to light. In some embodiments, the biomass-oxidizer can be regenerated by oxygen gas. In some embodiments, the biomass-oxidizer comprises a polyoxometalate. In some embodiments, the biomass-oxidizer is a polyoxometalate selected from the group consisting of phosphomolybdic acid (PMo₁₂O₄₀), phosphotungistic acid (PW₁₂O₄₀), vanadium-substituted phosphomolybdic acid (PMo₉V₃O₄₀), addenda keggin type polyoxometalate (H₃PW₁₁MoO₄₀), and mixtures thereof. The biomass-oxidizer can comprise a metal ion, in some embodiments.

In some embodiments, the biomass-oxidizer is present in the anode-side composition in an amount of 0.5% to 50% (e.g., 5% to 10%), by weight of the composition. In some embodiments, the anode-side composition further comprises a contaminant. In some embodiments, the contaminant comprises a metal ion, an inorganic nonmetal species or organic containing the element Nitrogen, Sulfur, or Phosphorus. In some embodiments, the anode-side composition further comprising an accelerant. In some embodiments, the accelerant is selected from the group consisting of Lewis acids, Brønsted acids, Lewis bases, and mixtures thereof. In some embodiments, the accelerant improves the reduction degree of the biomass-oxidizer. In some embodiments, the accelerant comprises a transition metal ion. In some embodiments, the accelerant is present in the composition in an amount of 1 ppm to 2% (e.g., 0.5% to 2%) by weight of the composition. In some embodiments, the water is present in the anode-side composition in an amount of 1% to 99% (e.g., 40% to 70%), by weight of the composition. Methods of making and using the anode-side compositions are also disclosed herein.

A fuel cell is disclosed, comprising a fuel comprising the anode-side composition, an anode electrode in fluid communication with the fuel, a proton exchange membrane, having a first side and a second side, the first side communication with the anode electrode a cathode electrode in communication with the second side of the proton exchange membrane, and a load circuit in electrical communication with the anode electrode and cathode electrode. In some embodiments, the fuel comprises the anode-side composition. In some embodiments, the fuel cell comprises an oxidizer solution comprising the cathode-side compositions disclosed herein, in fluid communication with the cathode electrode. In some embodiments, the fuel cell comprises an oxidizer gas mixing tank in fluid communication with the oxidizer solution, adapted to receive an oxidizer gas.

In some embodiments, the portion of the fuel in fluid communication with the anode electrode is at a temperature of 22° C. to 150° C. In some embodiments, the anode electrode comprises a carbon felt or graphite material. In some embodiments, the anode electrode comprises a plurality of layers of a carbon felt or graphite material. In some embodiments, the anode electrode does not comprise a surface catalyst. In some embodiments, the anode electrode comprises a surface catalyst. In some embodiments, the surface catalyst comprises a catalyst selected from the group consisting of: noble metal ions, metal oxides, and mixtures thereof. In some embodiments, the proton exchange membrane is a material adapted to be permeable to protons, and not to electrons. In some embodiments, the proton exchange membrane is made of a sulfonated tetrafluoroethylene-based fluoropolymer-copolymer. In some embodiments, the proton exchange membrane comprises a sulfonated tetrafluoroethylene-based fluoropolymer-copolymer having the molecular formula C₇HF₁₃O₅S.C₂F₄. In some embodiments, the proton exchange membrane comprises a ceramic semipermeable membrane. In some embodiments, the proton exchange membrane comprises polybenzimidazole. In some embodiments, the proton exchange membrane comprises phosphoric acid. In some embodiments, the cathode electrode comprises a carbon felt or graphite material. In some embodiments, the cathode electrode comprises a plurality of layers of a carbon felt or graphite material. In some embodiments, the cathode electrode does not contain a surface catalyst. In some embodiments, the cathode electrode contains a surface catalyst. In some embodiments, the surface catalyst is selected from the group consisting of: noble metal ions, metal oxides, and mixtures thereof. In some embodiments, the fuel cell further comprises a gaseous oxidizer in communication with the cathode electrode. In some embodiments, the oxidizer gas comprises air. In some embodiments, the oxidizer gas comprises oxygen gas.

A first method of operating a fuel cell is disclosed, which can comprise reducing a fuel comprising an anode-side composition, pumping the fuel through a flow plate in communication with an anode electrode of a fuel cell comprising the anode electrode, a proton exchange membrane having a first and a second side, the first side in communication with the anode electrode, and the second side in communication with a cathode electrode, and a load circuit, pumping an oxidizer gas through a flow plate in communication with the cathode electrode, and connecting a load to the load circuit.

A second method of operating a fuel cell is disclosed, which can comprise reducing a fuel, pumping the fuel through a flow plate in communication with an anode electrode of a fuel cell comprising the anode electrode, a proton exchange membrane having a first and a second side, the first side in communication with the anode electrode, and the second side in communication with a cathode electrode, and a load circuit, pumping an oxidizer solution comprising a cathode-side composition through a flow plate in communication with the cathode electrode of a fuel cell, pumping the oxidizer solution through a gas mixing tank, pumping an oxidizing gas through the gas mixing tank, and connecting a load to the load circuit.

In some embodiments, the oxidizing gas comprises oxygen gas. In some embodiments, the oxidizing gas comprises air. In some embodiments, the reducing the fuel comprises heating the fuel. In some embodiments, reducing the fuel comprises heating the fuel to a temperature of 22° C. to 350° C. In some embodiments, reducing the fuel comprises illuminating the fuel with a light source. In some embodiments, the light source comprises an artificial light source. In some embodiments, the light source comprises the sun. In some embodiments, the light source provides 1 mW/cm² to 100 mW/cm² of light energy to the fuel. In some embodiments, the light source provides light having a wavelength of 380 nm to 750 nm. In some embodiments, the light source provides light having a wavelength of 510 nm to 720 nm. In some embodiments, the fuel receives light having a wavelength of 10 nm to 380 nm. In some embodiments, the fuel is pumped through the flow plate in communication with the anode electrode at a temperature of 22° C. to 150° C. In some embodiments, the anode electrode comprises a carbon felt or graphite material. In some embodiments, the anode electrode comprises a plurality of layers of a carbon felt or graphite material. In some embodiments, the anode electrode does not contain a surface catalyst. In some embodiments, the anode electrode contains a surface catalyst. In some embodiments, the surface catalyst comprises a catalyst selected from the group consisting of: noble metal ions, metal oxides, and mixtures thereof. In some embodiments, the proton exchange membrane comprises a material adapted to be permeable to protons, and not to electrons. In some embodiments, the proton exchange membrane comprises a sulfonated tetrafluoroethylene-based fluoropolymer-copolymer. In some embodiments, the proton exchange membrane comprises a sulfonated tetrafluoroethylene-based fluoropolymer-copolymer having the molecular formula C₇HF₁₃O₅S.C₂F₄. In some embodiments, the proton exchange membrane comprises a ceramic semipermeable membrane. In some embodiments, the proton exchange membrane comprises polybenzimidazole. In some embodiments, the proton exchange membrane comprises phosphoric acid. In some embodiments, the cathode electrode comprises a carbon felt or graphite material. In some embodiments, the cathode electrode comprises a plurality of layers of a carbon felt or graphite material. In some embodiments, the cathode electrode does not contain a surface catalyst. In some embodiments, the cathode electrode contains a surface catalyst. In some embodiments, the surface catalyst is selected from the group consisting of: noble metal ions, metal oxides, and mixtures thereof.

The details of one or more embodiments are set forth in the description below. Other features, objects, and advantages will be apparent from the description and drawings, and from the claims.

### BRIEF DESCRIPTION OF THE FIGURES

The following Figures depict one or more embodiments disclosed herein, and are not necessarily drawn to scale.

FIG. 1 depicts a fuel cell in accordance with an embodiment disclosed herein.

FIG. 2 depicts a fuel cell having a gaseous oxidizer in accordance with an embodiment disclosed herein.

FIG. 3 depicts a fuel cell having a liquid oxidizer in accordance with an embodiment disclosed herein.

FIG. 4 depicts a direct biomass fuel cell coupled with biomass-POM-I solution anode tank and POM-II-oxygen cathode tank.

FIG. 5 depicts an oxidation and reduction cycle in accordance with an embodiment disclosed herein.

FIG. 6 depicts the FT-IR spectrum of native starch and starch-H₃PMo₁₂O₄₀ (PMo₁₂) complex after light irradiation.

FIG. 7 depicts molecular weight distributions of starches with different reaction periods measured by gel permeation chromatography (GPC).

FIG. 8 depicts ¹H NMR spectrum of final products in the degradation of starch.

FIG. 9 depicts ¹³C NMR spectrum of final products in the degradation of starch.

FIG. 10 depicts an emission gas collection experiment apparatus used for gas chromatography (GC) analysis.

FIG. 11 depicts ³¹P NMR spectrum of reaction solution after several repeated irradiation and discharge cycles.

FIG. 12 depicts voltage-current density and power-current density plots with different polyoxometalates (POMs) used in a solar-induced fuel cell in accordance with an embodiment disclosed herein.

FIG. 13 depicts the electron transfer and pH changes of a starch and PMo₁₂ composition when exposed to light in a temperature-controlled environment for eighty hours, followed by discharge through a fuel cell for nine hours.

FIG. 14 depicts the electron transfer and pH changes of a starch and PMo₁₂ composition when heated to 95° C. in a dark environment for five hours, followed by discharge through a fuel cell for twelve hours.

FIG. 15 depicts Faradic efficiency versus time curve for light and heat degradation processes.

FIG. 16 depicts experimentally determined extinction coefficients with different concentrations of phosphomolybdic blue solution, including pure deionized water as a control.

FIG. 17 depicts an experimental apparatus for testing the light-to-heat conversion efficiency of different concentrations of phosphomolybdic blue solution, including pure deionized water as a control.

FIG. 18 depicts the change in temperature over time of different concentrations of phosphomolybdic blue solution, including pure deionized water as a control.

FIG. 19 depicts the change in temperature over time of a solution containing starch and PMo₁₂, including pure deionized water as a control.

FIG. 20 depicts a calibration curve for determining the reduction degree of PMo₁₂ based on absorbance of light with a wavelength of about 700 nm.

FIG. 21 depicts the absorbance of a starch and PMo₁₂ composition when exposed to light for various intervals.

FIG. 22 depicts the absorbance of a starch and PMo₁₂ composition when exposed to heat for various intervals.

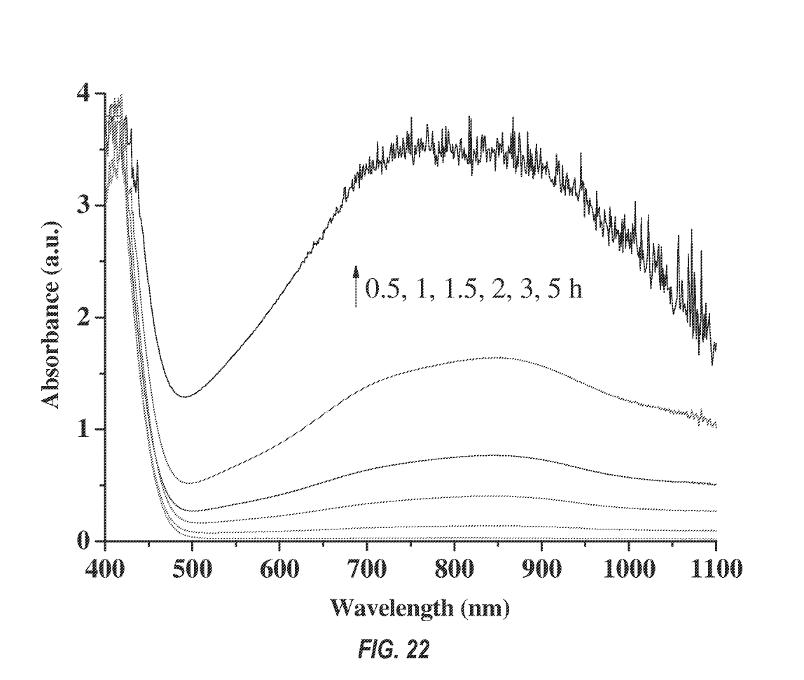

FIG. 23 depicts voltage-current density and power-current density plots of several compositions used to power a fuel cell with varying current levels, where the compositions contain starch and a PMo₁₂ that is exposed to heat or light, including a first control composition containing no PMo₁₂, and a second control composition containing starch and PMo₁₂ composition that was not exposed to light or heat.

FIG. 24 depicts voltage-current density and power-current density plots of a starch and PMo₁₂ composition at varying current levels, where the composition is used to power a fuel cell, and is exposed to light for three cycles.

FIG. 25 depicts the current discharged by a composition of starch and PMo₁₂ when irradiated with light at 100 mW/cm² and heated to 95° C., and discharged across a load of 1.6 Ω.

FIG. 26 depicts voltage-current density and power-current density plots of several compositions used to power a fuel cell with varying current levels, where the compositions contain PMo₁₂ and various types of biomasses.

FIG. 27 depicts voltage-current density and power-current density plots of several compositions used to power a fuel cell with varying current levels, where the compositions contain PMo₁₂, cellulose, and an accelerant, including a control with no accelerant.

FIG. 28 depicts a comparison of ³¹P NMR spectra of H₃PMo₁₂O₄₀, H₃PW₁₂O₄₀ and synthesized H₃PW₁₁MoO₄₀.

FIG. 29 depicts a proposed reaction pathway in the degradation of glucose with POM-I in a direct biomass fuel cell.

FIG. 30 depicts a calibration curve for POM-I solution with different reduction degrees.

FIG. 31 depicts the UV-Vis absorbance of glucose-POM-I reaction solution during the thermal degradation process (diluted to 50 mmol/L).

FIG. 32 depicts the number of electrons transferred over time during the illumination reduction.

FIG. 33 depicts the number of electrons transferred over time during thermal reduction.

FIG. 34 depicts the ³¹P NMR spectrum of synthesized POM-II.

FIG. 35 depicts the ⁵¹V NMR spectrum of synthesized POM-II.

FIG. 36 depicts the relationship of log r of oxygen oxidation of POM-II solution on the reduction degree of oxygen oxidation of different sodium substitute salts of POM-II, wherein r is the rate of reaction calculated in mol e⁻¹ l⁻¹ h⁻¹.

FIG. 37 depicts the relationship of log r of oxygen oxidation of POM-II solution on the reduction degree of oxygen oxidation of different concentration of 2Na substitute salts of POM-II, wherein r is the rate of reaction calculated in mol e⁻¹ l⁻¹ h⁻¹.

FIG. 38 depicts the total organic carbon (TOC) analysis of the anode electrolyte solution in repeated thermal reduction-discharge cycles.

FIG. 39 depicts voltage-current density and power-current density plots for glucose-POM-I reaction system with different light irradiation time.

FIG. 40 depicts voltage-current density and power-current density plots for a glucose-POM-I reaction system with different reaction time at elevated temperature (100° C.).

FIG. 41 depicts ¹H NMR (solvent D₂O) of final products in the degradation of glucose with POM-I.

FIG. 42 depicts ¹³C NMR spectrum (solvent D₂O) of final products in the degradation of glucose with POM-I.

FIG. 43 depicts Faradic efficiency versus time curve in a direct biomass fuel cell at room temperature using preheated glucose-POM-I solution as anode electrolyte.

FIG. 44 depicts voltage-current density and power-current density plots for different biomasses at 80° C.

FIG. 45 depicts the colors of different electrolyte solutions used in the direct biomass fuel cell.

FIG. 46 depicts the power density during continuous operation of a direct biomass fuel cell at 80° C. for 4 hours.

FIG. 47 depicts voltage-current density and power density-current density of the biomass fuel cell at 80° C. using ascorbic acid as fuel.

FIG. 48 depicts redox potentials of POM-II (0.3 mol/l) and glucose-POM-I (2 mol/l and 0.3 mol/l respectively) electrolyte as a function of reduction degree.

FIG. 49 depicts cyclic voltammograms of initial POM-I solution on graphite electrode with the scan rate 10 mV/s at room temperature.

FIG. 50 depicts cyclic voltammograms of thermal reduced glucose-POM-I solution (2 mol/L and 0.3 mol/L respectively) on graphite electrode with the scan rate 10 mV/s at room temperature.

FIG. 51 depicts the redox rates (corresponding to different colors) of oxygen and 2 Na substituted POM-II solution with different concentration and reduction degree.

FIG. 52 depicts a pathway of redox reactions in a fuel cell.

Like reference symbols in the various drawings indicate like elements.

### DETAILED DESCRIPTION

Disclosed herein are a variety of compositions including, but not limited to, (1) compositions comprising an oxidizer, water, and optionally a neutralizer, and (2) compositions comprising biomass, a biomass-oxidizer, water, and optionally an accelerant. In some embodiments, the compositions comprising an oxidizer, water, and optionally a neutralizer can be used on the cathode-side of a fuel cell. These cathode-side compositions can, among other things, allow a fuel cell to operate without a gas/liquid interface at the cathode electrode, prevent waste products from flooding the cathode-side of the proton exchange membrane, operate without a precious metal catalyst at the cathode (although a precious metal catalyst can be used), eliminate the need to monitor the moisture level of the proton exchange membrane, resist catalyst poisoning due to impurities in the cathode-side composition, or a combination thereof. In some embodiments, the compositions comprising biomass, a biomass-oxidizer, water, and optionally an accelerant can be used on the anode-side of a fuel cell. These anode-side compositions can, among other things, allow for direct conversion of a wide variety of biomass materials (including polymeric biomasses), allow for direct conversion of some synthetic materials, resist catalyst poisoning due to impurities, operate with a contaminated or unprocessed biomass, use light or heat to improve the efficiency of a fuel cell (including solar power or waste heat), operate without a precious metal catalyst at the anode electrode (although a precious metal catalyst can be used), enable use with multiple electrodes in series or a 3-D cathode in cathode, or a combination thereof. Fuel cells comprising those compositions are also disclosed herein.

### Anode-Side Compositions

The anode-side compositions disclosed herein can comprise biomass, a biomass-oxidizer, water, and a reaction product. The anode-side compositions disclosed herein can further comprise an accelerant.

### Biomass

The anode-side compositions disclosed herein can comprise biomass. The biomass can comprise any material that can degrade by giving up a proton (H⁺) electron (e⁻) pair. In some embodiments, biomass is biological material derived from living, or recently living organisms. In some embodiments, the biomass is synthetic. In some embodiments, the biomass comprises a naturally derived material that has been chemically modified. In some embodiments, the biomass comprises organic matter. The organic matter can include, but is not limited to, sugars, starches, fats, proteins, lignocellulosic biomass, carbohydrate polymers, aromatic polymers, cellulose, carboxymethylcellulose, hemicellulose, microcrystalline cellulose, lignin, ethanol, butanol, dimethylfuran, gamma-Valerolactone, uronic acids, phenols, phenylproponols, xylose, miscanthus, switchgrass, hemp, corn, poplar, willow, sourghum, sugarcane, bamboo, eucalyptus, palm oil, wheat, straw, food waste, industrial waste, wood products, household waste, yard clippings, wood chips, tree materials, allamanda, D-glucose, pectin, and combinations thereof.

The biomass can further comprise a contaminant. The contaminant can be any material or impurity contained alongside or within the biomass. In some embodiments, the contaminant comprises sulfur and its compounds, phosphate and its compounds, CO, polymer and materials that can absorb or deposit on the membrane. In some embodiments, the contaminants can comprise materials that can poison a noble metal catalyst, such as a platinum catalyst.

The biomass can be present in the composition in any amount sufficient to undergo oxidation by a biomass-oxidizer. In some embodiments, the biomass is present in the composition in an amount of 0.5% or greater (e.g., 1% or greater, 5% or greater, 10% or greater, 20% or greater, 30% or greater, 40% or greater, 50% or greater, or 60% or greater), by weight of the composition. In some embodiments, the biomass is present in the composition in an amount of 70% or less (e.g., 60% or less, 50% or less, 40% or less, 30% or less, 20% or less, 10% or less, 5% or less, or 1% or less), by weight of the composition. In some embodiments, the biomass is present in the composition in an amount of from 0.5% to 70% (e.g., 0.5% to 6%, 0.5% to 50%, 0.5% to 40%, 0.5% to 30%, 0.5% to 20%, 0.5% to 10%, 0.5% to 5%, 5% to 70%, 10% to 70%, 20% to 70%, 30% to 70%, 40% to 70%, 50% to 70%, 60% to 70%, 0.5% to 10%, 10% to 20%, 20% to 30%, 30% to 40%, 40% to 50%, 50% to 60%, 60% to 70%, 0.5% to 20%, 10% to 30%, 20% to 40%, 30% to 50%, 40% to 60%, 50% to 70%, 0.5% to 30%, 10% to 40%, 20% to 50%, 30% to 60%, 40% to 70%, 0.5% to 40%, 10% to 50%, 20% to 60%, 30% to 70%, 0.5% to 50%, 10% to 60%, 20% to 70%, 0.5% to 60%, 10% to 70%), by weight of the composition.

The biomass can comprise particles that are, in some embodiments, spherical, angular, platy (or hyperplaty), or a combination thereof. The biomass particles can have a shape selected for a variety of reasons. For instance, the biomass particles' shape can be selected to facilitate the speed of reaction with the biomass-oxidizer. The biomass particles' shape can be selected, for instance, based on surface area, ease of handling, availability, or a combination thereof. The biomass particles' shape can be natural (e.g., derived by natural wind or water erosion) or artificially derived (e.g., by manufacturing aspects such as with particular grinding equipment and methods). The biomass can have a shape factor of from to 1:1 to 140:1. The shape factor is a measure of an average value (on a weight average basis) of the ratio of mean particle diameter to particle thickness for a population of particles of varying size and shape as measured using the electrical conductivity method and apparatus described in U.S. Pat. No. 5,128,606, which is incorporated by reference herein in its entirety. In some embodiments, the shape factor of the biomass particles is 1:1 or greater (e.g., 1.5:1 or greater, 2:1 or greater, 2.5:1 or greater, 3:1 or greater, 3.5:1 or greater, 4:1 or greater, 4.5:1 or greater, 5:1 or greater, 5.5:1 or greater, 6:1 or greater, 7:1 or greater, 8:1 or greater, 9:1 or greater, 10:1 or greater, 20:1 or greater, 30:1 or greater, 40:1 or greater, 50:1 or greater, 60:1 or greater, 70:1 or greater, 80:1 or greater, 90:1 or greater, 100:1 or greater, 110:1 or greater, 120:1 or greater, or 130:1 or greater). In some embodiments, the shape factor of the biomass particles is 140:1 or less (e.g., 130:1 or less, 120:1 or less, 110:1 or less, 100:1 or less, 90:1 or less, 80:1 or less, 70:1 or less, 60:1 or less, 50:1 or less, 40:1 or less, 30:1 or less, 20:1 or less, 10:1 or less, 9:1 or less, 8:1 or less, 7:1 or less, 6:1 or less, 5.5:1 or less, 5:1 or less, 4.5:1 or less, 4:1 or less, 3.5:1 or less, 3:1 or less, 2.5:1 or less, 2:1 or less, or 1.5:1 or less). In some embodiments, the shape factor of the biomass particles is from 1:1 to 140:1 (e.g., 1:1 to 2:1, 2:1 to 3:1, 3:1 to 4:1, 4:1 to 5:1, 5:1 to 10:1, 10:1 to 30:1, 30:1 to 80:1, 80:1 to 110:1, 110:1 to 140:1, 1:1 to 20:1, 20:1 to 120:1, or 120:1 to 140:1).

The size of the biomass particles can be chosen for a variety of reasons, including but not limited to cost, mechanical properties, energy output, availability, or a combination thereof. For instance, the biomass particles' size can be chosen to minimize the amount of biomass needed or to speed the reaction with the biomass-oxidizer. For example, in some embodiments, biomass particles having a smaller average particle size react more quickly with the biomass-oxidizer. In some embodiments, the average particle size of the biomass particles is 15 nm or greater (e.g., 25 nm or greater, 50 nm or greater, 100 nm or greater, 150 nm or greater, 200 nm or greater, 250 nm or greater, 300 nm or greater, 350 nm or greater, 400 nm or greater, 450 nm or greater, 500 nm or greater, 550 nm or greater, 600 nm or greater, 650 nm or greater, 700 nm or greater, 750 nm or greater, 800 nm or greater, 850 nm or greater, 900 nm or greater, 950 nm or greater, 1 μm or greater, 2 μm or greater, 3 μm or greater, 4 μm or greater, 5 μm or greater, 6 μm or greater, 7 μm or greater, 8 μm or greater, 9 μm or greater, 10 μm or greater). In some embodiments, the average particle size of the biomass particles is 10 μm or less (e.g., 10 μm or less, 9 μm or less, 8 μm or less, 7 μm or less, 6 μm or less, 5 μm or less, 4 μm or less, 3 μm or less, 2 μm or less, 1 μm or less, 950 nm or less, 900 nm or less, 850 nm or less, 800 nm or less, 750 nm or less, 700 nm or less, 650 nm or less, 600 nm or less, 550 nm or less, 500 nm or less, 450 nm or less, 400 nm or less, 350 nm or less, 300 nm or less, 250 nm or less, 200 nm or less, 150 nm or less, 100 nm or less, 50 nm or less, 25 nm or less). In some embodiments, the average particle size of the particles is from 15 nm to 10 μm (e.g., 25 nm to 50 nm, 50 nm to 100 nm, 100 nm to 250 nm, 250 nm to 500 nm, 500 nm to 750 nm, 750 nm to 1 μm, 1 μm to 2.5 μm, 2.5 μm to 5 μm, 5 μm to 10 μm, 25 nm to 100 nm, 100 nm to 500 nm, 500 nm to 1 μm, 1 μm to 5 μm, 2.5 μm to 10 μm, 25 nm to 250 nm, 50 nm to 500 nm, 100 nm to 750 nm, 250 nm to 1 μm, 500 nm to 2.5 μm, 750 nm to 5 μm, 1 μm to 10 μm, 25 nm to 500 nm, 50 nm to 750 nm, 100 nm to 1 μm, 250 nm to 2.5 μm, 500 nm to 5 μm, 750 nm to 10 μm, 25 nm to 750 nm, 50 nm to 1 μm, 100 nm to 2.5 μm, 250 nm to 5 μm, 500 nm to 10 μm, 25 nm to 2.5 μm, 50 nm to 5 μm, 100 nm to 10 μm, 25 nm to 5 μm, 50 nm to 10 μm, 25 nm to 10 μm). Average particle size is determined by light scattering.

### Biomass-Oxidizer

The anode-side compositions disclosed herein can comprise a biomass-oxidizer. The biomass-oxidizer can be any material that can separate protons and electrons from biomass. In some embodiments, the biomass-oxidizer is a material that separates protons and electrons from biomass to serve as fuel in the anode of a fuel cell. In some embodiments, the biomass-oxidizer is water-soluble. In some embodiments, the biomass-oxidizer can be regenerated or reduced by oxygen gas. In some embodiments, the biomass-oxidizer has a lower redox potential than oxygen gas. In some embodiments, the biomass-oxidizer comprises a polyoxometalate.

Polyoxometalates (POMs) are inorganic metal-oxygen cluster anions. The clusters contain symmetrical core assemblies of MOₙ, where the M is a metal selected from the group of: Molybdenum (Mo), Tungsten (W), Vanadium (V), Titanium (Ti), Zirconium (Zr), Niobium (Nb), Manganese (Mn), Cobalt (Co), Copper (Cu), Zinc (Zn), Iron (Fe), Nickel (Ni), Cerium (Ce), Chromium (Cr), Silver (Ag), Gold (Au), Palladium (Pd), Platinum (Pt), Ruthenium (Ru), Yttrium (Y), Erbium (Er), Europium (Eu), Lanthanum (La), and Osmium (Os). The number of Oxygen atoms (n) can vary with the oxidation state of the metal M. The POMs can also contain one or a few heteroatoms X selected from the group of: Phosphorus (P), Silicon (Si), Carbon (C), Arsenic (As), Chlorine (Cl), Gallium (Ga), Germanium (Ge), Antimony (Sb), Tin (Sn), Iodine (I), Boron (B), Aluminum (Al), Bromine (Br), Bismuth (Bi), Arsenic (As), Sulfur (S), Oxygen (O), Selenium (Se), Indium (In), and Lead (Pb). These groups of atoms can assemble themselves in to various shapes such as Keggin-type POMs, having the overall formula XM₁₂O₄₀, Wells-Dawson-type POMs, having the overall formula X₂M₁₈O₆₂, Dexter-Silverton-type POMs, having the overall formula XM₁₂O₄₂, and Anderson-Evans type POMs having the overall formula XM₆O₂₄. In some embodiments, the POMs contain only metal-oxygen clusters having the same metal M, and the same number of oxygen atoms n. In some embodiments, the POMs contain heterogenous combinations of metal-oxygen clusters, with different metals M, and different numbers of atoms n. As would be understood by a person having ordinary skill in the art, POMs may comprise other structures, combinations of metal-oxygen clusters, and other heteroatoms. By way of example, and not limitation, some POMs comprise phosphomolybdic acid (PMo₁₂O₄₀), phosphotungistic acid (PW₁₂O₄₀), vanadium-substituted phosphomolybdic acid (PMo₉V₃O₄₀), addenda Keggin-type POM (H₃PW₁₁MoO₄₀), or mixtures thereof.

In some embodiments, the biomass-oxidizer can comprise simple metal ions, such as the redox pairs of transition metal ions, main group metal ions and the metal complexes associated with inorganic or organic ligands, redox pairs of ions or molecules such as Fe³⁺/Fe²⁺, Cu²⁺/Cu⁺, and inorganic redox pairs such as I₂/I³⁻, TEMPO (2,2,6,6-tetramethylpiperidinyloxy) and its reduced form.

The biomass-oxidizer can be purchased commercially or prepared by any method known in the art. For instance, phosphomolybidic acid (H₃[PMo₁₂O₄₀]) may be purchased from TCI America®, or phosphotungstic acid (H₃[PW₁₂O₄₀]) may be purchased from Chem-impex Int'l, Inc, each of which can be used as a biomass-oxidizer. Addenda Keggin-type POM H₃PW₁₁MoO₄₀ can be synthesized by refluxing a solution of mixed phosphomolybdic acid and phosphotungstic acid with the mole ratio of 1:11 (n(H₃[PMo₁₂O₄₀]): n(H₃[PW₁₂O₄₀])=1:11) for 1 hour. Then water can then be evaporated in air at 80° C. until reaching the concentration of 0.3 mol/L. High-vanadium Mo—V-phosphoric heteropoly acid aqueous solutions with modified composition H₁₂P₃Mo₁₈V₇O₈₅ may be synthesized using MoO₃ (purchased commercially from Alfa Aesar), V₂O₅ (purchased commercially from Alfa Aesar) and H₃PO₄ (purchased commercially from Alfa Aesar). The synthesis process can then comprise: producing a first solution by adding 0.079 mol (14.32 g) V₂O₅ to 600 ml cooled DI water (˜4° C.), then adding 90 ml H₂O₂ (purchased commercially from Aldrich) with magnetic stirring and cooling by ice. After dissolving V₂O₅, 0.02 mol (2.3 g) of H₃PO₄ (85 wt %) can be added and the mixture can be stirred at room temperature to decompose the extra H₂O₂ for 2 hours. Then, a second solution can be prepared by adding 0.81 mol (116.64 g) MoO₃ and 0.095 mol (10.96 g) H₃PO₄ (85 wt %) to 1,000 ml DI water, and boiling. After the second solution turns to yellow, 200 ml of the first can be added gradually (200 ml for one time), and the suspension can be heated to its boiling temperature. After all of the first solution is added, the suspension can be until MoO₃ dissolves completely and is evaporated to 150 ml. The concentration of High-vanadium Mo—V-phosphoric heteropoly acid obtained by that method, when used, was 0.3 mol/L. Sodium salts of High-vanadium Mo—V-phosphoric heteropoly acid can be synthesized by neutralization of the heteropoly acid POM-II with sodium carbonate (commercially available from Aldrich).

The biomass-oxidizer can be present in the composition in any amount sufficient to cause the biomass to oxidize. In some embodiments, the biomass-oxidizer is present in the composition in an amount of 0.5% or greater (e.g., 1% or greater, 5% or greater, 10% or greater, 20% or greater, 30% or greater, 40% or greater, 50% or greater, or 60% or greater), by weight of the composition. In some embodiments, the biomass-oxidizer is present in the composition in an amount of 50% or less (e.g., 40% or less, 30% or less, 20% or less, 10% or less, 5% or less, or 1% or less), by weight of the composition. In some embodiments, the biomass-oxidizer is present in the composition in an amount of from 0.5% to 50% (e.g., 0.5% to 1%, 1% to 5%, 5% to 10%, 10% to 20%, 20% to 30%, 30% to 40%, 40% to 50%, 50% to 60%, 60% to 65%, 0.5% to 5%, 1% to 10%, 5% to 20%, 10% to 30%, 20% to 40%, 30% to 50%, 40% to 60%, 50% to 65%, 0.5% to 10%, 1% to 20%, 5% to 30%, 10% to 40%, 20% to 50%, 30% to 60%, 40% to 65%, 0.5% to 20%, 1% to 30%, 5% to 40%, 10% to 50%, 20% to 60%, 30% to 65%, 0.5% to 30%, 1% to 40%, 5% to 50%, 10% to 60%, 20% to 65%, 0.5% to 50%, 1% to 60%, 5% to 65%, 0.5% to 60%, 1% to 65%, 0.5% to 65%,), by weight of the composition.

### Water

The anode-side compositions disclosed herein can comprise water. In some embodiments, water can be substituted by or included with another solvent, including any solvent that will not be oxidized by the biomass-oxidizer. In an embodiment, water can be replaced by light CO₂ as a solvent. In some embodiments, water is present in the composition in an amount of 0.5% or greater (e.g., 5% or greater, 10% or greater, 25% or greater, 33% or greater, 50% or greater, 75% or greater, 90% or greater, 95% or greater), by weight of the composition. In some embodiments, the water is present in the composition in an amount of 99% or less (e.g., 95% or less, 90% or less, 75% or less, 50% or less, 33% or less, 25% or less, 10% or less, 5% or less), by weight of the composition. In some embodiments, the water is present in the composition in an amount of from 0.5% to 99% (e.g., 0.5% to 5%, 5% to 10%, 10% to 25%, 25% to 33%, 33% to 50%, 50% to 75%, 75% to 90%, 90% to 95%, 95% to 99%, 0.5% to 10%, 5% to 25%, 10% to 33%, 25% to 50%, 33% to 75%, 50% to 90%, 75% to 95%, 90% to 99%, 0.5% to 25%, 5% to 33%, 10% to 50%, 25% to 75%, 33% to 90%, 50% to 95%, 75% to 99%, 0.5% to 33%, 5% to 50%, 10% to 75%, 25% to 90%, 33% to 95%, 50% to 99%, 0.5% to 50%, 5% to 75%, 10% to 90%, 25% to 95%, 33% to 99%, 0.5% to 90%, 5% to 95%, 10% to 99%, 0.5% to 95%, 5% to 99%), by weight of the composition.

### Accelerant

The anode-side compositions disclosed herein can further comprise an accelerant. In some embodiments, the accelerant is added to the composition to help cleave glycosidic bonds present in many biomass materials, such as cellulose. In some embodiments, the accelerant comprises a Lewis acid, Brønsted acid, Lewis base, or a mixture thereof. The Lewis acid can include Sn⁴⁺, Fe³⁺ and Cu²⁺ etc. In some embodiments, the accelerant comprises transition metal ions, main group metal ions and the metal complexes associated with inorganic or organic ligands, redox pairs of ions or molecules such as Fe³⁺/Fe²⁺, Cu²⁺/Cu⁺, and inorganic redox pairs such as I₂/I₃⁻, TEMPO (2,2,6,6-tetramethylpiperidinyloxy) and its reduced form.

The accelerant can be provided in any amount to, for instance, aid the solution in cleaving glycosidic bonds. In some embodiments, the accelerant is present in the composition in an amount of 100 ppm or greater (e.g., 250 ppm or greater, 500 ppm or greater, 750 ppm or greater, 0.1% or greater, 0.5% or greater, 0.75% or greater, 1% or greater, 1.5% or greater), by weight of the composition. In some embodiments, the accelerant is present in the composition in an amount of 2% or less (e.g., 1.5% or less, 1% or less, 0.75% or less, 0.5% or less, 0.1% or less, 750 ppm or less, 500 ppm or less, 250 ppm or less), by weight of the composition. In some embodiments, the accelerant is present in the composition in an amount of from 100 ppm to 2% (e.g., 100 ppm to 250 ppm, 250 ppm to 500 ppm, 500 ppm to 750 ppm, 750 ppm to 0.1%, 0.1% to 0.5%, 0.5% to 0.75%, 0.75% to 1%, 1% to 1.5%, 1.5% to 2%, 100 ppm to 500 ppm, 250 ppm to 750 ppm, 500 ppm to 0.1%, 750 ppm to 0.5%, 0.1% to 0.75%, 0.5% to 1%, 0.75% to 1.5%, 1% to 2%, 100 ppm to 750 ppm, 250 ppm to 0.1%, 500 ppm to 0.5%, 750 ppm to 0.75%, 0.1% to 1%, 0.5% to 1.5%, 0.75% to 2%, 100 ppm to 0.1%, 250 ppm to 0.5%, 500 ppm to 0.75%, 750 ppm to 1%, 0.1% to 1.5%, 0.5% to 2%, 100 ppm to 0.5%, 250 ppm to 0.75%, 500 ppm to 1%, 750 ppm to 1.5%, 0.1% to 2%, 100 ppm to 1%, 250 ppm to 1.5%, 500 ppm to 2%, 100 ppm to 1.5%, 250 ppm to 2%, 100 ppm to 2%), by weight of the composition.

Accelerants can be purchased commercially or prepared by any method known in the art. For example, Sn⁴⁺ can be added to the composition by adding SnCl₄ (such as is commercially available from Alfa Aesar) to the composition. Fe³⁺ can be added to the composition by adding Fe₂(SO₄)₃ (such as is commercially available from Alfa Aesar) to the composition. Cu²⁺ can be added to the composition by adding CuSO₄ (such as is commercially available from Alfa Aesar) to the composition.

### Reaction Product

In the anode-side compositions disclosed herein, the biomass and biomass-oxidant can combine to produce a reaction product. In some embodiments, when the biomass and biomass-oxidant are combined, the biomass-oxidant can oxidize the biomass by removing an electron (e⁻) from an oxygen molecule of the biomass, and bonding with a proton (H⁺) from the biomass. By this process, the biomass-oxidant obtains an electron/proton pair that can be used to power a fuel cell. At the same time, the biomass loses an electron and a proton, which can cause the biomass to degrade. Where the biomass comprises a polymer, this oxidation can cause the bond between biomass monomers to break, which can cause polymers to break down into oligomers or monomers. Thus, the reaction product can further comprise reduced biomass-oxidant, and oxidized biomass. Where the biomass is a polymer, the reaction product can comprise biomass oligomers or monomers. In some embodiments, the biomass and biomass-oxidant reaction product can cause the protonation of water, resulting in an increased concentration of hydronium atoms. This can cause the pH of the reaction product to increase.

In some embodiments, the oxidation of biomass by a biomass-oxidant can be activated or enhanced by either heating, exposure to light, or both. In some embodiments, the biomass and biomass-oxidant do not form a reaction product until exposed to heat or light. In some embodiments, the biomass and biomass-oxidant can produce a reaction product at a rate that increases with heat and/or light exposure. In some embodiments, the biomass and biomass-oxidant can form a reaction product without exposure to heat or light. In some embodiments, biomass and biomass-oxidant can form a reaction product without exposure to heat or light, but the biomass and biomass oxidant may produce a reaction product at an increased rate with heat or light exposure.

In some embodiments, the reduced biomass-oxidizer may be regenerated through oxidation. In some embodiments, this regeneration can be caused by passing the biomass and biomass-oxidant reaction product through the anode flow plate of a fuel cell, where the cathode flow plate is provided with an oxidizer. In some embodiments, the reduced biomass oxidizer in the reaction product is itself oxidized. Thus, the reaction product can further comprise the oxidized biomass, including oligomers or monomers, and a non-reduced biomass oxidant. In some embodiments, the oxidation of reduced biomass-oxidant reaction product can cause the de-protonation of water, resulting in an increased concentration of hydroxide atoms. This can cause the pH of the reaction product to decrease.

In some embodiments, the non-reduced biomass-oxidant can further oxidize the oxidized biomass, producing a further-oxidized biomass, and a reduced biomass-oxidant. In some embodiments, the reduced biomass oxidant can be repeatedly regenerated, as discussed above, and repeatedly oxidize the biomass, including biomass oligomers and monomers.

### Method of Making the Anode-Side Composition

In some embodiments, the anode-side compositions can be formed by combining a biomass and a biomass-oxidizer in water. In some embodiments, the anode-side compositions can be formed by further adding an accelerant. In some embodiments, the anode-side composition can further be exposed to heat, or light, in sufficient quantities for the biomass-oxidizer to oxidize the biomass and form a reaction product. In some embodiments, the anode-side composition can contain a reduced biomass-oxidizer as a reaction product, which can be regenerated by adding a gas containing oxygen to the biomass oxidizer. In some embodiments, a reduced biomass-oxidizer reaction product can be regenerated by circulating the anode-side composition through the anode-side of a fuel cell, where an oxidant gas is provided to the cathode-side of the fuel cell.

### Cathode-Side Compositions

The cathode-side compositions disclosed herein can comprise an oxidizer, water, and optionally a neutralizer and a reaction product of the oxidizer and neutralizer.

### Oxidizer

The cathode-side compositions disclosed herein comprise an oxidizer. The oxidizer can be any material that can accept an electron from another material. The oxidizer can be any material described above as a biomass-oxidizer. In some embodiments, the oxidizer is the POM known as high-vanadium Mo—V-phosphoric heteropoly acid (H₁₂P₃Mo₁₈V₇O₈₅). When used in fuel cells with the anode-side compositions disclosed herein, the cathode-side composition can be selected to have a lower redox potential than the anode-side composition.

The oxidizer can be present in the cathode-side composition in any amount sufficient to reduce an anode-side composition, or other material whose oxidation is desirable. In some embodiments, the oxidizer is present in the composition in an amount of 0.5% or greater (e.g., 1% or greater, 5% or greater, 10% or greater, 20% or greater, 30% or greater, 40% or greater, 50% or greater, or 60% or greater), by weight of the composition. In some embodiments, the oxidizer is present in the composition in an amount of 50% or less (e.g., 40% or less, 30% or less, 20% or less, 10% or less, 5% or less, or 1% or less), by weight of the composition. In some embodiments, the oxidizer is present in the composition in an amount of from 0.5% to 50% (e.g., 0.5% to 1%, 1% to 5%, 5% to 10%, 10% to 20%, 20% to 30%, 30% to 40%, 40% to 50%, 50% to 60%, 60% to 65%, 0.5% to 5%, 1% to 10%, 5% to 20%, 10% to 30%, 20% to 40%, 30% to 50%, 40% to 60%, 50% to 65%, 0.5% to 10%, 1% to 20%, 5% to 30%, 10% to 40%, 20% to 50%, 30% to 60%, 40% to 65%, 0.5% to 20%, 1% to 30%, 5% to 40%, 10% to 50%, 20% to 60%, 30% to 65%, 0.5% to 30%, 1% to 40%, 5% to 50%, 10% to 60%, 20% to 65%, 0.5% to 50%, 1% to 60%, 5% to 65%, 0.5% to 60%, 1% to 65%, 0.5% to 65%,), by weight of the composition.

### Neutralizer

In some embodiments, the cathode-side compositions can contain a neutralizer. In some embodiments, the neutralizer may consist of any of: alkali metals, alkali earth elements, transition metal cations, organic cations, and mixtures thereof. In some embodiments, the redox reaction rate can increase with a decrease in acidity of cathode-side compositions. In some embodiments, added cations can bond with, and neutralize, free hydroxide (OH⁻) ions, causing the pH to rise. This can be accomplished by adding some neutralizer-containing compounds to the cathode-side composition. By way of example, and not limitation, sodium ions (Na⁺) can be added to the cathode-side composition by adding sodium carbonate (NaCO₂), which can react with the cathode-side composition by releasing Na⁺ ions into the composition, along with carbon dioxide gas. As would be recognized by a person having ordinary skill in the art, neutralizers can be added to the cathode-side composition by any method known in the art, including adding neutralizers directly, or neutralizer-containing compounds that release metal cations in solution.

Neutralizers can be added, for instance, in any amount sufficient to neutralize free hydroxide ions. In some embodiments, the neutralizer can be present in the composition in a molar ratio of 4:1 parts oxidizer to neutralizer or greater (e.g., 3:1 or greater, 2:1 or greater, 1:1 or greater, 1:2 or greater, 1:3 or greater, 1:4 or greater, 1:5 or greater, 1:7 or greater). In some embodiments, the neutralizer can be present in the composition in a molar ratio of 1:10 parts oxidizer to neutralizer (e.g., 1:7 or less, 1:5 or less, 1:4 or less, 1:3 or less, 1:2 or less, 1:1 or less, 2:1 or less, 3:1 or less), by weight of the composition. In some embodiments, the neutralizer can be present in the composition in a molar ratio of 4:1 to 1:10 parts oxidizer to neutralizer or greater (e.g., 4:1 to 3:1, 3:1 to 2:1, 2:1 to 1:1, 1:1 to 1:2, 1:2 to 1:3, 1:3 to 1:4, 1:4 to 1:5, 1:5 to 1:7, 1:7 to 1:10, 4:1 to 2:1, 3:1 to 1:1, 2:1 to 1:2, 1:1 to 1:3, 1:2 to 1:4, 1:3 to 1:5, 1:4 to 1:7, 1:5 to 1:10, 4:1 to 1:1, 3:1 to 1:2, 2:1 to 1:3, 1:1 to 1:4, 1:2 to 1:5, 1:3 to 1:7, 1:4 to 1:10, 4:1 to 1:2, 3:1 to 1:3, 2:1 to 1:4, 1:1 to 1:5, 1:2 to 1:7, 1:3 to 1:10, 4:1 to 1:3, 3:1 to 1:4, 2:1 to 1:5, 1:1 to 1:7, 1:2 to 1:10, 4:1 to 1:5, 3:1 to 1:7, 2:1 to 1:10, 4:1 to 1:7, 3:1 to 1:10, 4:1 to 1:10).

### Water

The cathode-side compositions disclosed herein can comprise water. In some embodiments, water can be substituted by another solvent, including any solvent that will not be oxidized by the oxidizer. In an embodiment, water can be replaced by light CO₂ as a solvent. In some embodiments, water is present in the composition in an amount of 0.5% or greater (e.g., 5% or greater, 10% or greater, 25% or greater, 33% or greater, 50% or greater, 75% or greater, 90% or greater, 95% or greater), by weight of the composition. In some embodiments, the water is present in the composition in an amount of 99% or less (e.g., 95% or less, 90% or less, 75% or less, 50% or less, 33% or less, 25% or less, 10% or less, 5% or less), by weight of the composition. In some embodiments, the water is present in the composition in an amount of from 0.5% to 99% (e.g., 0.5% to 5%, 5% to 10%, 10% to 25%, 25% to 33%, 33% to 50%, 50% to 75%, 75% to 90%, 90% to 95%, 95% to 99%, 0.5% to 10%, 5% to 25%, 10% to 33%, 25% to 50%, 33% to 75%, 50% to 90%, 75% to 95%, 90% to 99%, 0.5% to 25%, 5% to 33%, 10% to 50%, 25% to 75%, 33% to 90%, 50% to 95%, 75% to 99%, 0.5% to 33%, 5% to 50%, 10% to 75%, 25% to 90%, 33% to 95%, 50% to 99%, 0.5% to 50%, 5% to 75%, 10% to 90%, 25% to 95%, 33% to 99%, 0.5% to 90%, 5% to 95%, 10% to 99%, 0.5% to 95%, 5% to 99%), by weight of the composition.

### Reaction Product

The cathode-side compositions disclosed herein can further comprise a reaction product. In some embodiments, the oxidizer in the cathode-side composition can reduce, forming a reduced-oxidizer. In some embodiments, the reduced oxidizer can be a waste product. By way of example, and not limitation, where the oxidizer is oxygen, the reduced oxidizer can be water. In some embodiments, the reduced oxidizer is a reduced catalyst, such as a POM. In some embodiments, the reduced oxidizer can be regenerated by adding an oxidant gas to the cathode-side composition, such as a gas containing oxygen.

In some embodiments, a neutralizer can be added to the cathode-side composition. In some embodiments, the neutralizers neutralize hydroxide ions present in the cathode-side composition, causing the pH of the cathode-side composition to increase. Thus, in some embodiments, the cathode-side composition reaction product further comprises neutralized hydroxide atoms. By way of example, and not limitation, where sodium ions are added to the cathode-side composition (Na⁺), sodium hydroxide (NaOH) can be formed by the combination of sodium and hydroxide. As would be understood by any person having ordinary skill in the art, other alkali-metal compounds can be formed in a cathode-side reaction product, including potassium hydroxide (KOH), and lithium hydroxide (LiOH).

### Method of Making the Cathode-Side Composition

In some embodiments, the cathode-side composition can be made by adding an oxidant to water. In some embodiments, the oxidant is a POM, such as phosphomolybdic acid (PMo₁₂O₄₀), phosphotungistic acid (PW₁₂O₄₀), vanadium-substituted phosphomolybdic acid (PMo₉V₃O₄₀), addenda keggin type POM (H₃PW₁₁MoO₄₀), or a mixture thereof. In some embodiments, making the cathode-side composition can include adding an oxidant and a neutralizer to water. In some embodiments, the step of adding a neutralizer to water can include adding a compound containing a neutralizer to water.

### Methods of Using the Compositions Disclosed Herein

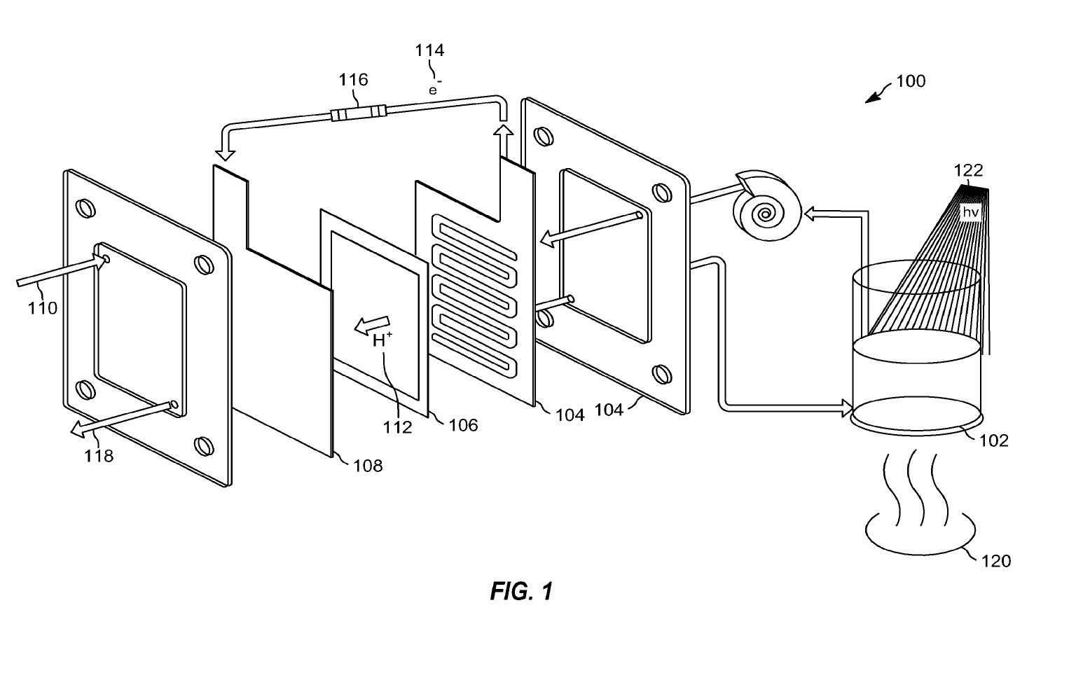

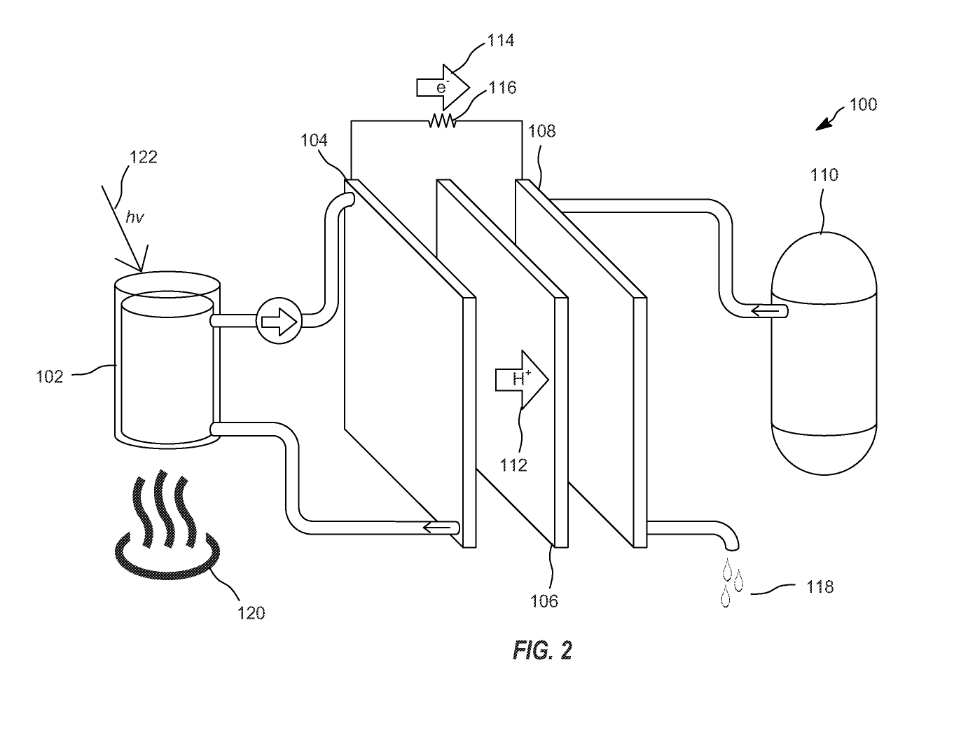

The compositions disclosed herein can be used in a variety of applications including, but not limited to, fuel systems. Some embodiments can comprise a fuel cell 100 as shown in FIG. 1 and FIG. 2. A fuel cell 100 can comprise a fuel 102, an anode flow plate 104, a proton exchange membrane 106, a cathode flow plate 108, and an oxidizer 110. In some fuel cells, the fuel 102 can be pumped through the anode flow plate 104, where it comes into fluid communication with one side of a proton exchange membrane 106. In some fuel cells, an oxidizer 110, such as oxygen gas, can be pumped into the cathode flow plate 108, where it comes into fluid communication with the opposite side of the proton exchange membrane 106. Where the fuel 102 has a higher reduction potential than the oxidizer 110, the fuel can donate a proton (H⁺) 112 and an electron (e⁻) 114 to the oxidizer 110. In some embodiments, the proton exchange membrane 106 can be more permeable to protons 112 than to electrons 114. As a result, protons can more freely pass through the proton exchange membrane 106, and some electrons can be diverted through the load circuit 116, and can generate a current. The proton exchange membrane can be made of a sulfonated tetrafluoroethylene-based fluoropolymer-copolymer, such as those with a molecular formula formula C₇HF₁₃O₅S.C₂F₄, and those sold as NAFION®, a trademark owned by E. I. Du Pont De Nemours And Company Corp. of Delaware. The proton exchange membrane can be made of a ceramic semipermeable membrane, polybenzimidazole, or phosphoric acid. In some embodiments, the fuel 102 can be provided to the anode flow plate 104, at a temperature of 22° C. to 150° C. Where a proton 112 and electron 114 have passed to the cathode flow plate 108, the oxidizer 110 can be reduced, which can produce a waste product 118. For example, where a gas containing oxygen is used as the oxidizer 110, the proton 112 and electron 114 can combine with oxygen gas to produce water vapor as a waste product 118.

In some embodiments, the fuel 102 can be an anode-side composition as described herein, comprising biomass and a biomass-oxidizer. In some embodiments, the biomass-oxidizer can be sensitive to heat 120 and/or light 106. Some biomass-oxidizers, such as POMs, can oxidize biomass by removing a proton and electron pair from a biomass when exposed to heat 120 or light 122. When the biomass-oxidizer oxidizes biomass, the oxidizer reduces. Thus, when the biomass-oxidizer can be pumped through the anode flow plate 104, the biomass oxidizer can donate a proton (H⁺) 112 and an electron (e⁻) 114 to the oxidizer 110 through the proton exchange membrane 106 and load circuit 116.

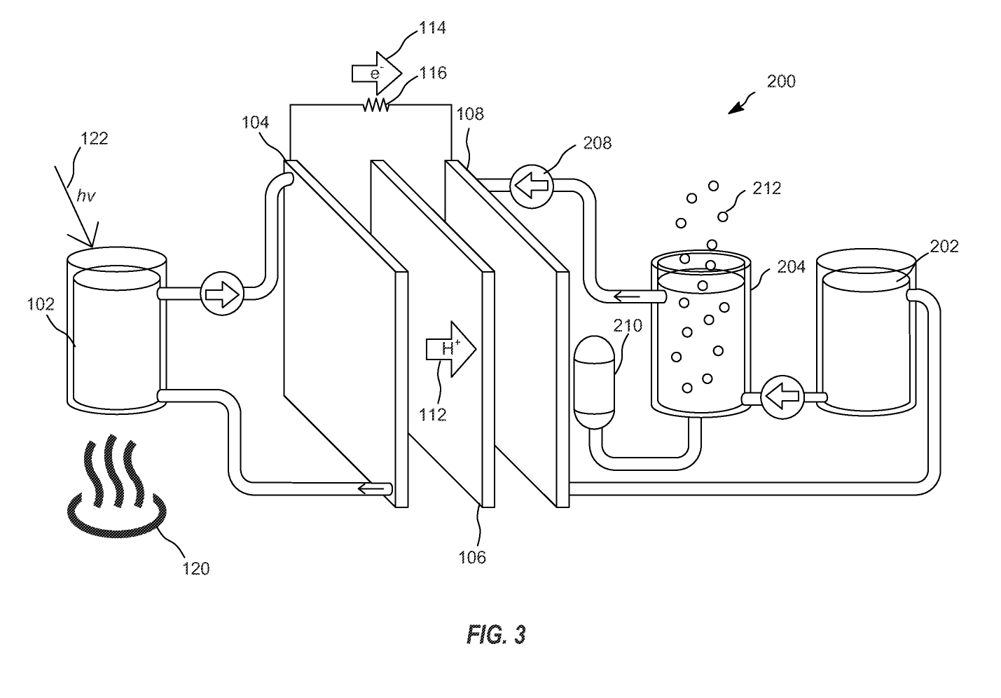

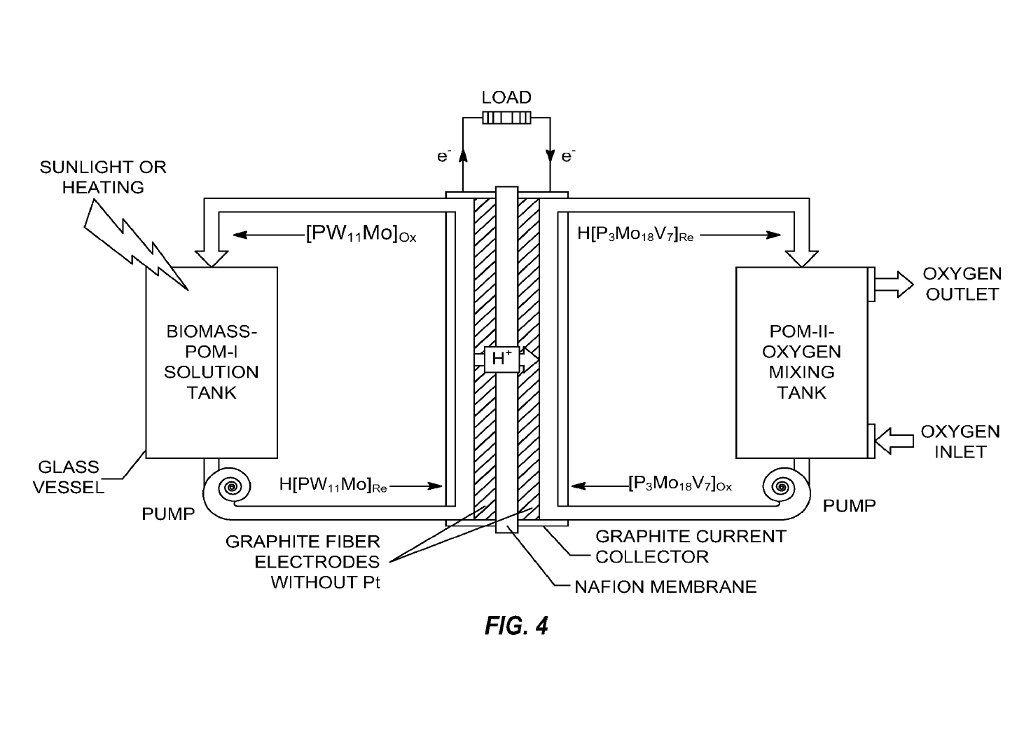

Some embodiments can comprise a fuel cell with a liquid oxidant 200, as shown in FIG. 3. A fuel cell with a liquid oxidant 200 can further comprise a liquid oxidant 202, a means for regenerating the liquid oxidant 204, a secondary oxidant 206, and an oxidant pump 208. Rather than passing a gas through the cathode flow plate 108, an oxidant pump 208 can pump the liquid oxidant 202 through the cathode flow plate 108. The liquid oxidant 202 can comprise an anode-side composition as described herein. In some embodiments, an oxidant catalyst can be regenerated. In an embodiment, an oxidant catalyst can be regenerated by bubbling a secondary oxidant 210, such as an oxygen-containing gas, through the liquid oxidant 202 in an oxidant exchange tank 204. When the liquid oxidant 202 can be regenerated by pumping a secondary oxidant 210 through the liquid oxidant 204, a waste gas 212 can be produced. Where the secondary oxidant can be an oxygen-containing gas, the waste gas 212 can comprise carbon dioxide gas. This process is also depicted in FIG. 4.

As described above, fuel cells can comprise at least four components: an anode, an electrolyte, a load circuit, and a cathode. At the anode, a reduction reaction generates an electron-proton pair. The positively charged proton (H⁺) may propagate through the electrolyte to the cathode. The electrolyte is less permeable to electrons than to protons, forcing electrons to travel through the load circuit. At the cathode, an oxidation reaction occurs, wherein the proton, electron, and an oxidant are combined into a waste product.

Some embodiments disclosed herein comprise a solar-induced hybrid fuel cell that directly consumes natural polymeric biomass, such as starch, lignin, cellulose, switchgrass or wood powders. In some embodiments, the biomass is oxidized by POMs in the solution under solar irradiation, and the reduced POM is oxidized by oxygen through an external circuit, producing electricity. Embodiments disclosed herein can have many advantages. First, a fuel cell that combines photochemical and solar-thermal biomass degradation in a single chemical process can be built, leading to high solar conversion and effective biomass degradation. Second, embodiments disclosed herein need not use expensive noble metals as anode catalysts, because the fuel oxidation reactions are catalyzed by POMs in the solution. Finally, some embodiments can be directly powered by unpurified polymeric biomasses, which can significantly reduce the fuel cell cost. In some embodiments, the power density of the fuel cells disclosed herein can reach 1 W/cm². In some embodiments, the power density of the fuel cells disclosed herein is up to 10,000 times greater than fuel cells currently on the market.

### No Precious Metal Electrode Required

In the fuel cells disclosed herein below, the catalytic reactions are mediated by the biomass-oxidizer, and not on the surface of an expensive and process-sensitive precious metal electrode or catalyst. Most biomass fuels, and even some artificial polymers and organic wastes, can be directly degraded by the fuel cells disclosed herein to provide electricity without using a precious metal catalyst. Contaminants, such as organic impurities in crude biomass can also be oxidized as fuels, and inorganic impurities will not poison the whole process because the biomass-oxidizers disclosed herein can be robust and self-healing. As a result, the fuels used in the disclosed fuel cells do not have to be pure. This can significantly reduce the cost of current fuel cell technology, and it widens the range of biomass fuels that can be used for electric power production. In embodiments where a metal catalyst is used, any type of surface catalyst can be used as is known in the art, such as those made of noble metals (Gold, Platinum, Iridium, Palladium, Osmium, Silver, Rhodium, and Ruthenium), metal oxides, and mixtures thereof.

### Methods of Using Compositions in Fuel Cells

By way of non-limiting illustration, examples of certain embodiments of the present disclosure are given below. In some embodiments, a fuel cell can be operated by reducing a fuel comprising an anode-side composition, as described herein. In some embodiments, a fuel cell can be operated by reducing a fuel other than an anode-side composition, as described herein, where the fuel has a higher redox potential than the oxidizer used. In some embodiments, the fuel cell can comprise a proton exchange membrane sandwiched between an anode flow plate, containing an anode, and a cathode flow plate, containing a cathode. In some embodiments, the anode and cathode are electrically connected through a load circuit. In some embodiments, the method of operating the fuel cell can comprise pumping the reduced fuel through the anode flow plate, and connecting a load to the load circuit.

The method of operating the fuel cell can further comprise heating the fuel. The method of operating the fuel cell can comprise heating the fuel to a temperature of 22° C. to 350° C. The method of operating the fuel cell can comprise illuminating the fuel with a light source. The method of operating the fuel cell can comprise illuminating the fuel with an artificial light source. The method of operating the fuel cell can comprise illuminating the fuel with the sun.

The method of operating the fuel cell can comprise illuminating the fuel with 1 mW/cm² to 100 mW/cm² of light energy. The method of operating the fuel cell can comprise using a light source that provides light with a wavelength of 380 nm to 750 nm, 510 nm to 720 nm, 10 nm to 380 nm, or any combination thereof. The method of operating the fuel cell can comprise pumping the fuel through the anode flow plate at a temperature of 22° C. to 150° C. The method of operating the fuel cell can comprise using a fuel cell wherein the anode electrode comprises one or a plurality of layers of a carbon felt or graphite material. The method of operating the fuel cell can comprise using a fuel cell wherein the anode electrode does not contain a surface catalyst. The method of operating the fuel cell can comprise using a fuel cell wherein the anode electrode contains a surface catalyst, such as a noble metal ion, metal oxide, or a mixture thereof.

In some embodiments, the fuel cell can further com further comprise a gaseous oxidizer. In these embodiments, the method of operating the fuel cell further comprises pumping an oxidizer gas through the cathode flow plate. In some embodiments, the oxidizing gas comprises oxygen gas. In some embodiments, the oxidizer gas comprises air. In some embodiments, the fuel cell can further comprise a liquid oxidizer, such as any of the cathode-side compositions described above. In these embodiments, the method of operating the fuel cell can further comprise pumping the cathode-side composition through the cathode flow plate, and connecting a load to the load circuit.

In some embodiments, the fuel cell operation methods may be performed where the proton exchange membrane comprises a material adapted to be permeable to protons, and not to electrons. In some embodiments, the proton exchange membrane can comprise a sulfonated tetrafluoroethylene-based fluoropolymer-copolymer, including those with molecular formula C₇HF₁₃O₅S.C₂F₄, and those commercially available under the mark NAFION®, such as NAFION® 115 and 117. In some embodiments, the proton exchange membrane can comprise a ceramic semipermeable membrane, polybenzimidazole, phosphoric acid, or combinations thereof. In some embodiments, the cathode electrode can comprise one or a plurality of more a carbon felt or graphite material. In some embodiments, the cathode electrode does not comprise a surface catalyst. In some embodiments, the cathode electrode can comprise a surface catalyst, such as those selected from the group consisting of: noble metal ions, metal oxides, and mixtures thereof.

### Examples & Test Methods

### Starch-PMo₁₂ Complexes

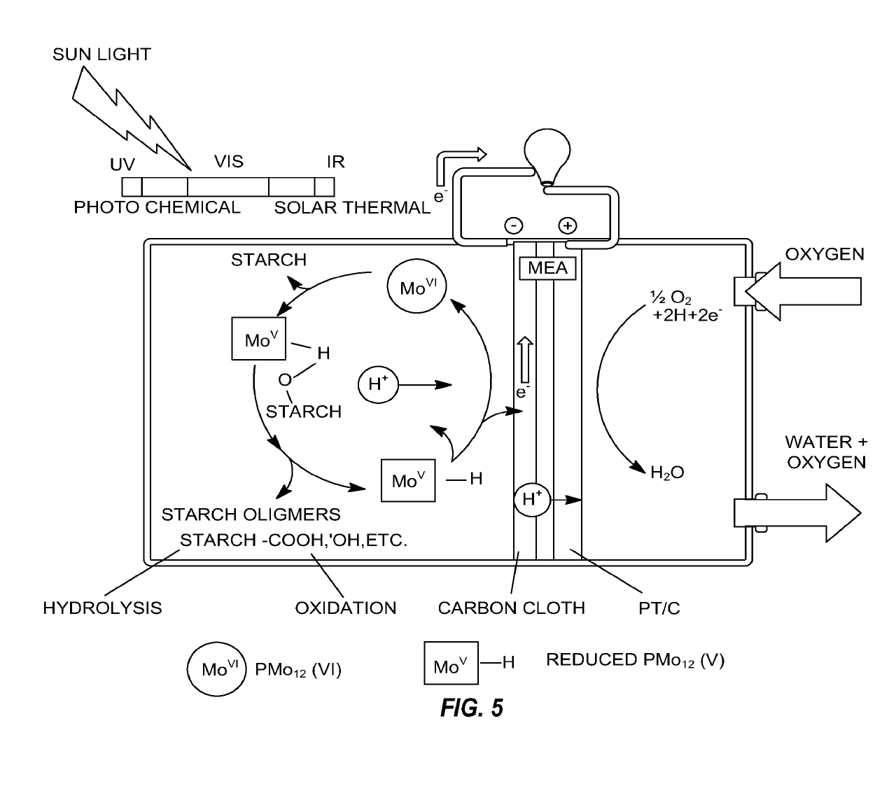

As described above, some anode-side compositions comprise biomass such as starch and a biomass-oxidizer, such as POMs. POMs can oxidize biomass when exposed to sunlight, separating protons and electrons from biomass to serve as fuel in the anode of a fuel cell. For example, PMo₁₂, a POM, oxidizes biomass when exposed to sunlight by reducing from Mo⁶⁺ to Mo⁵⁺. Mo⁵⁺ can be oxidized back to Mo⁶⁺ by oxygen through a catalytic electrochemical reaction, as illustrated in FIG. 5. Electron transfer from organics to POM under light irradiation could result in the formation of an intermolecular charge transfer complex as described in Yamase, T. Photo- and Elecrochromism of Polyoxometalates and Related Materials. Chemical Reviews 98, 307-326 (1998), the entire disclosure of which is incorporated herein by reference. According to this mechanism, the representative reaction in a starch-PMo₁₂ solution is as shown in equation (1).

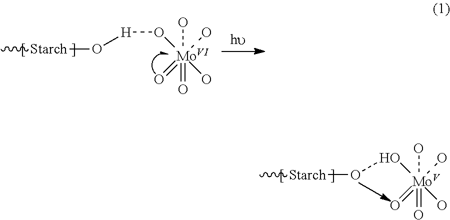

PMo₁₂ has a well-known Keggin structure, consisting of a central tetrahedral [PO₄] surrounded by twelve [MoO₆] octahedrons, which are photo-sensitive. Under short wavelength light irradiation, an O→Mo ligand-to-metal charge transfer can occur, where the 2p electron in the oxygen of [MoO₆] can be excited to the empty d orbital of Mo, which can change the electron configuration of Mo from d⁰ to d¹, and can leave a hole at an oxygen atom in the [MoO₆] octahedron. This hole can interact with one electron on the oxygen atom of a hydroxyl group of starch. Simultaneously, the hydrogen atom of the hydroxyl group can shift to the POM lattice, and interact with the d¹ electron, a thermally activated delocalization within the polyanion molecule. Thus, the intermolecular charge transfer (CT) complex can be thus formed, leading to the separation of photo-excited electrons and holes, stabilizing the reduced state of PMo₁₂.

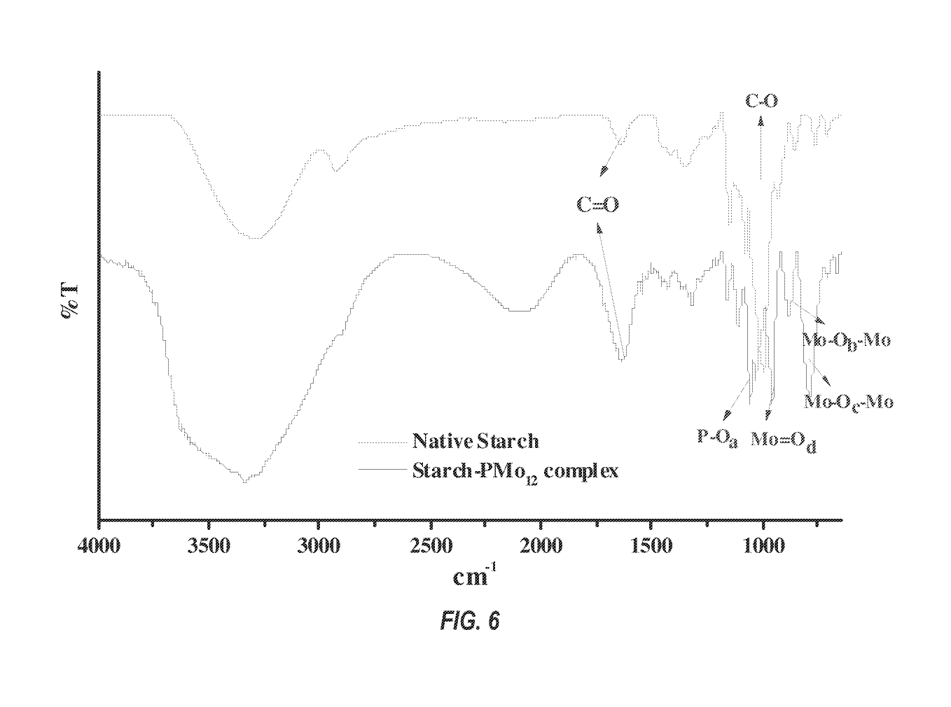

In several experiments discussed herein, a formed starch-PMo₁₂ complex was separated from the reaction solution and characterized by FT-IR, which provides evidence of the interaction between starch and PMo₁₂ (shown in FIG. 6).

| | Standard PMo₁₂ | Starch-PMo₁₂ complex |
|---|---|---|
| Peaks | (cm⁻¹) | (cm⁻¹) |
| υ(Mo—O_{c}—Mo) | 785 | 785 |
| υ(Mo—O_{b}—Mo) | 869 | 878 |
| υ(Mo═O_{d}) | 962 | 956 |
| υ(P—Oₐ) | 1068 | 1054 |

Because light irradiation also heats the starch-PMo₁₂ solution, the oxidation of biomass by POMs by light and heat can happen simultaneously in the presence of starch. As a result, a POM captures an electron and proton from starch, oxidizing and degrading the starch to oligomers and glucose derivatives as shown in equation (2). POMs can accept more than one electron per Keggin unit, which means the reduction degree of the POMs may increase.

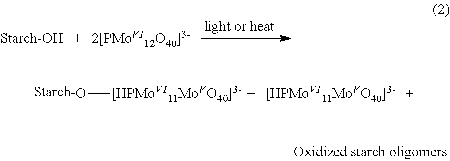

Although one Mo is reduced from Mo⁶⁺ to Mo⁵⁺ by forming a starch-POM complex, the total charge of the polyanion (—[HPMo^{VI}₁₁Mo^{V}O₄₀]³⁻) will not change because a proton is also transferred from starch to the POM complex at the same time. Because the standard redox potential of oxygen is higher than that of the reduced POM, the Mo⁵⁺ in the reduced PMo₁₂ can be oxidized at the anode by passing a proton through a membrane, and an electron through an external circuit, to O₂ molecules at the cathode. As a result, the reduced POM (Mo⁵⁺) gives one electron to the carbon anode and simultaneously releases a proton to the solution. The electron passes through the external circuit and is captured by oxygen to form water at the cathode. At the same time, the starch molecules associated with PMo₁₂ are released into solution. The net effect of the above reaction is that Mo⁵⁺ is oxidized back to Mo⁶⁺ at the anode, and the starch is oxidized through dehydrogenation by POM catalysis. Finally, the proton diffuses to the cathode side through the proton exchange membrane and combines with oxygen to form water. The entire discharge process is represented by equations (3) and (4),

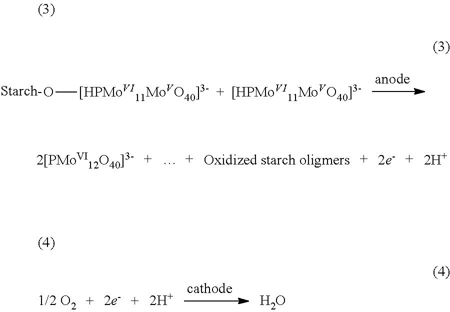

Starch, which acts as the electron and proton donor, can be directly oxidized under light radiation or hydrolyzed to small oligomers by the POM, and then continuously oxidized to a series of glucose derivatives such as aldehyde, ketones, and acids, as shown in equation (5):

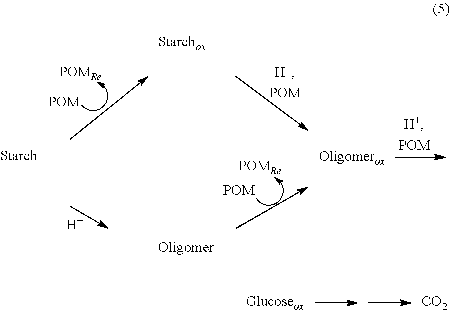

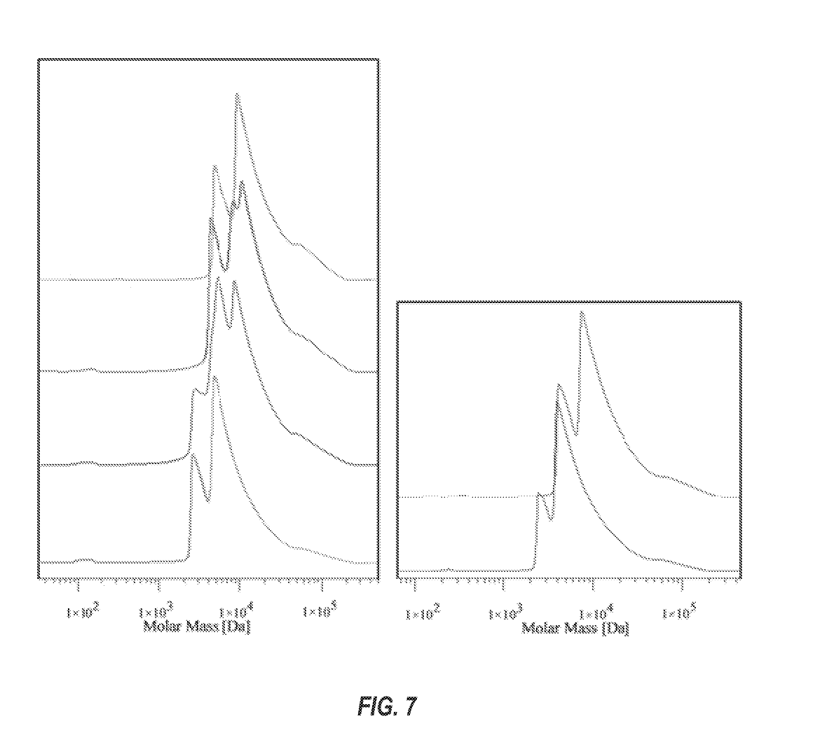

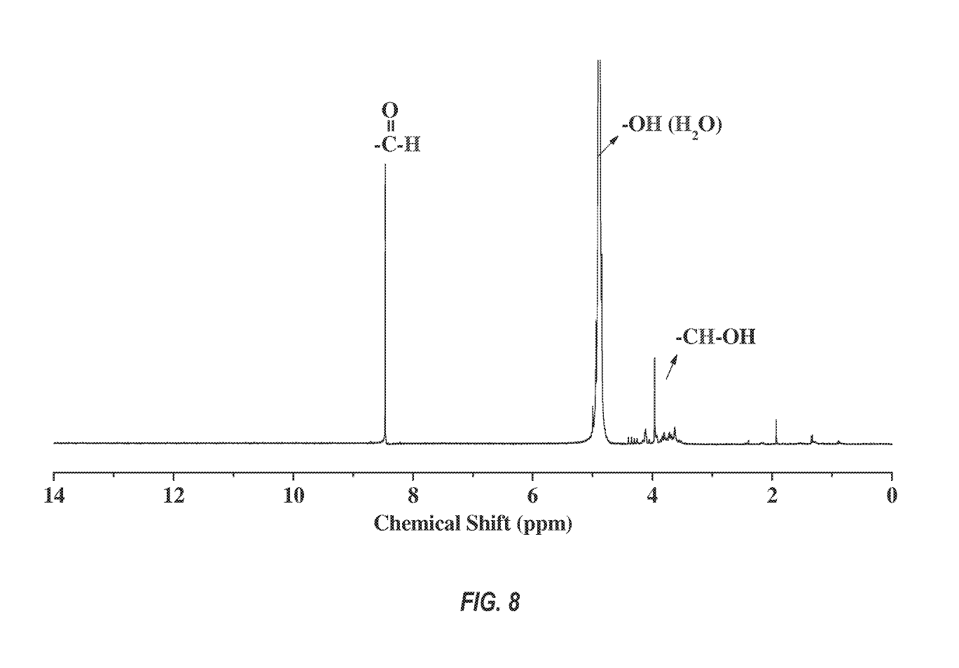

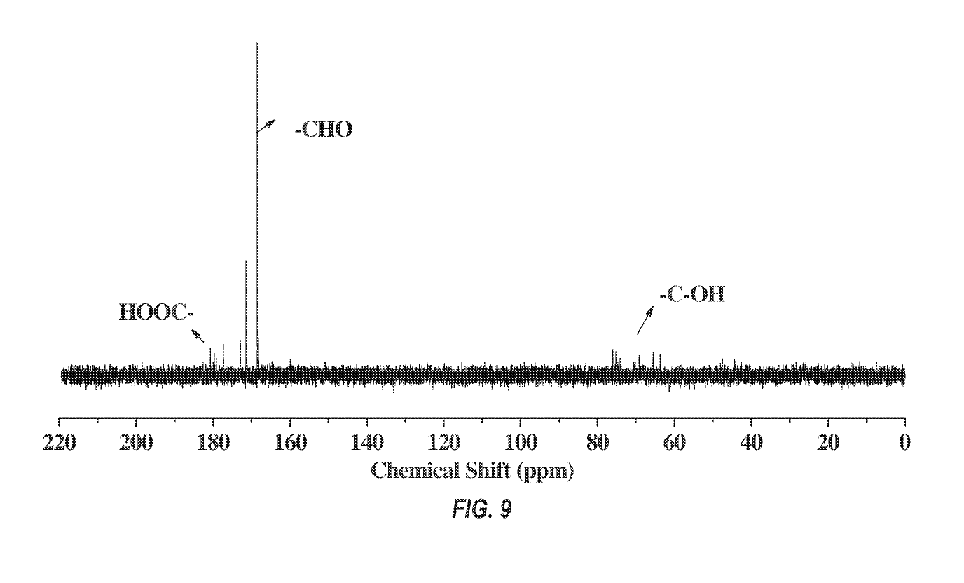

The direct oxidation of starch in the photochromic reaction was confirmed by FT-IR (FIG. 6), and the degradation and further oxidation of starch glucose derivatives was verified by gel permeation chromatography (GPC) (FIG. 7) and ¹H, ¹³C NMR analysis (FIG. 8 and FIG. 9).

| Sample | Mₙ (g/mol) |
|---|---|
| a1 | 12475; 5216 |
| a2 | 11878; 4611 |
| a3 | 10481; 5323; 2874 |
| a4 | 6823; 2844 |
| b1 | 9117; 4017 |
| b2 | 5759; 2642 |

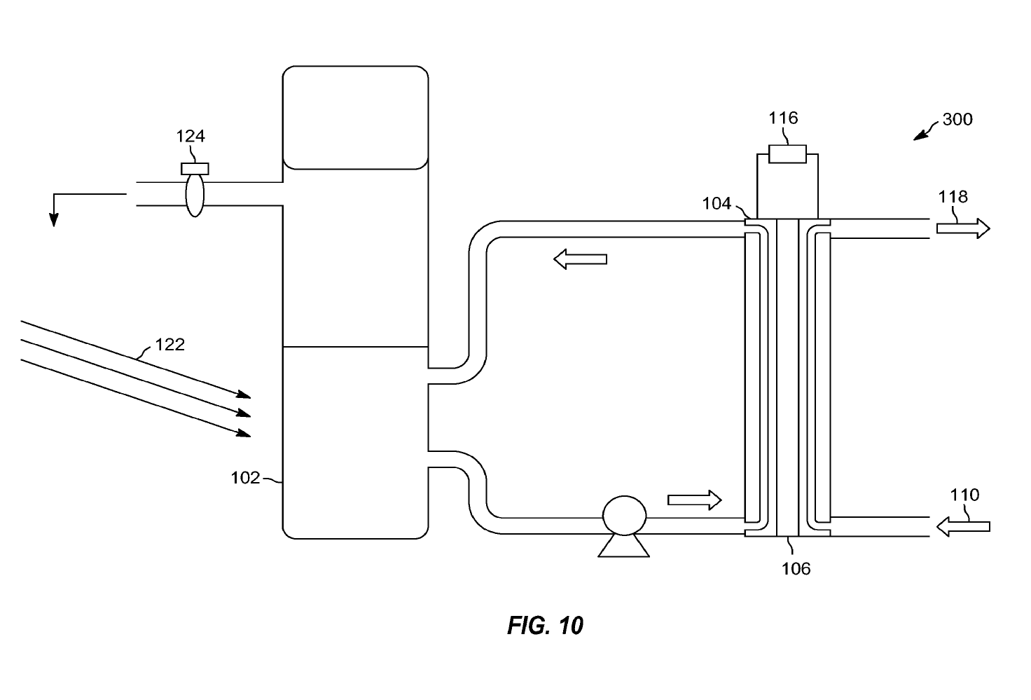

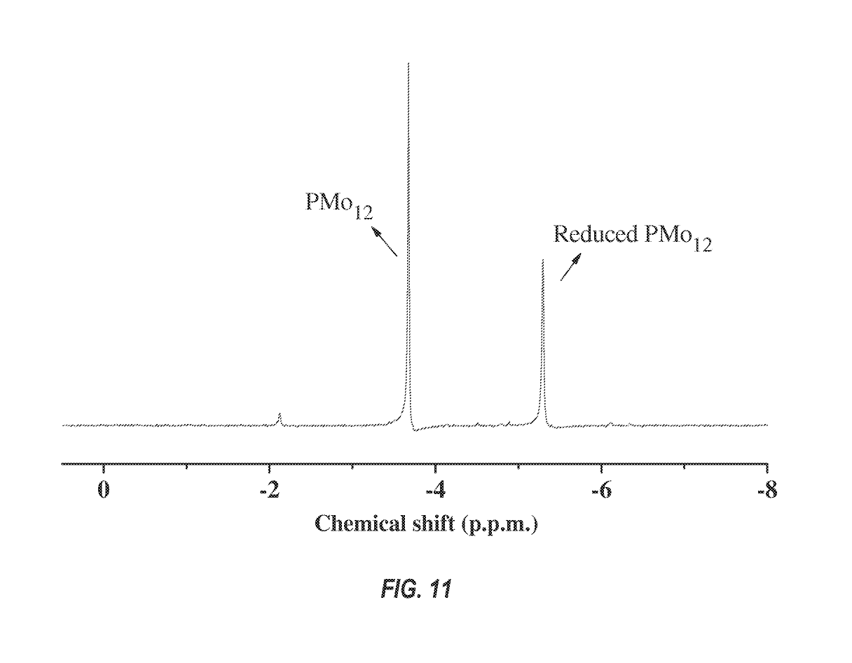

Additionally, CO₂ is recognized as the final product in many photo-degradation reactions of organic compounds by POMs, and the produced CO₂ was actually detected during the operation of the solar-induced hybrid fuel cell in this example. FIG. 10 depicts the experimental apparatus 300, including the gas collection tube 124. As the charge carrier in this example, PMo₁₂ is very stable in a solution acidified by H₃PO₄, which was verified during our repeated cycle test using P NMR analysis (FIG. 11).

| Results | Concentration (mol %) |
|---|---|
| Oxygen | 21.37 |
| Nitrogen | 77.98 |
| Carbon monoxide | 0.012 |
| Carbon dioxide | 0.628 |

The performance of solar-induced fuel cells may be associated with the reduction degree and redox potential of POMs. As described below, the power density gradually increased after three repeated light irradiation-discharge cycles. Correspondingly, the reduction degree of the POM increased from 1.23 to 2.4 electrons per Keggin unit after three repeated illumination/discharge cycles. Without wishing to be bound to theory, it is believed that the reason for the increase in reduction degree is that low molecular weight oligomers and oxidized derivatives (mainly aldehydes) were formed during the photo-catalytic reaction, which have greater reduction power and higher reactivity with the POM. Therefore, with repeated light irradiation-discharge cycles, more electrons were captured by each Keggin unit, but without major changes in their chemical structures.

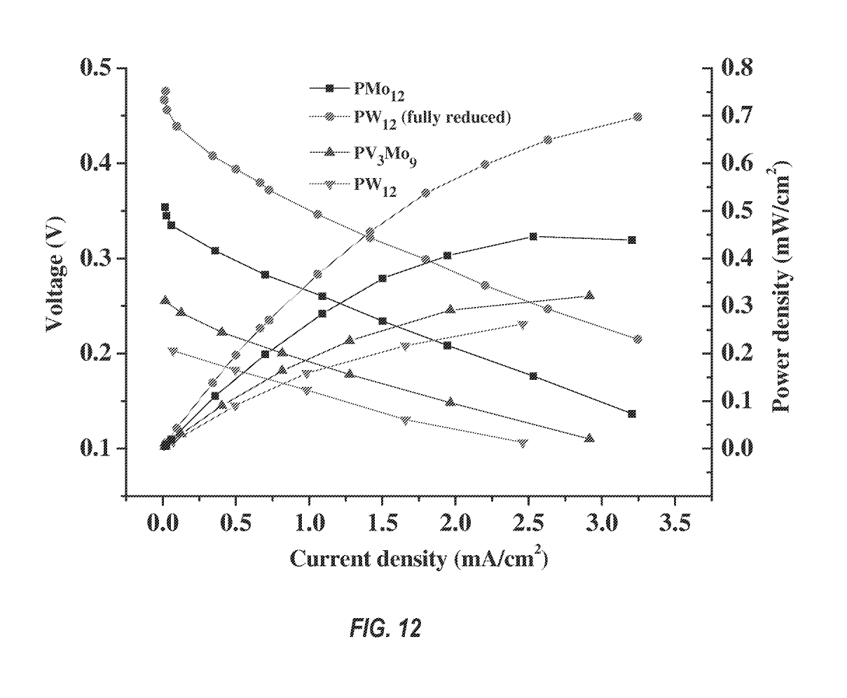

The power density of the cell may be affected by the redox potential of the POMs. As the charge carrier, POM is first reduced by oxidizing the biomass, and then the reduced POM is oxidized by oxygen. If the standard redox potential of POM is high, it has greater tendency to oxidize the biomass but lower tendency to be oxidized by oxygen. In the experiments described below three types of POMs (PMo₁₂, [PW₁₂O₄₀]³⁻, and [PV₃MO₉O₄₀]⁶⁻) with different redox potentials were used as the charge and proton carriers (FIG. 12).

### Faradic Efficiency

Faradic efficiency is considered as one important part of discharge efficiency. Faradic efficiency is defined as a ratio of the actual discharge capacity to the total electron charge transferred from the organics in the POM electrolyte solution. Faradic efficiency (ε_{F}) can be calculated with by equation (6):

$${ɛ}_{F} = \frac{{Q}_{Discharging}}{{Q}_{POM}} = \frac{{\int }_{0}^{t} I d t}{{FmVC}_{POM}} \qquad ( 6 )$$

where Q_{Discharging} is the experimental charge quantity calculated from the discharge current-time curve, and Q_{POM} is the maximum possible charge quantity released by reduced POM, calculated by spectrophotometry. I is the electric current obtained during the discharging process; n is number of electrons obtained per unit of POM; c_{POM} is the concentration of POM; V is the volume of electrolyte solution; and F is the Faraday constant.

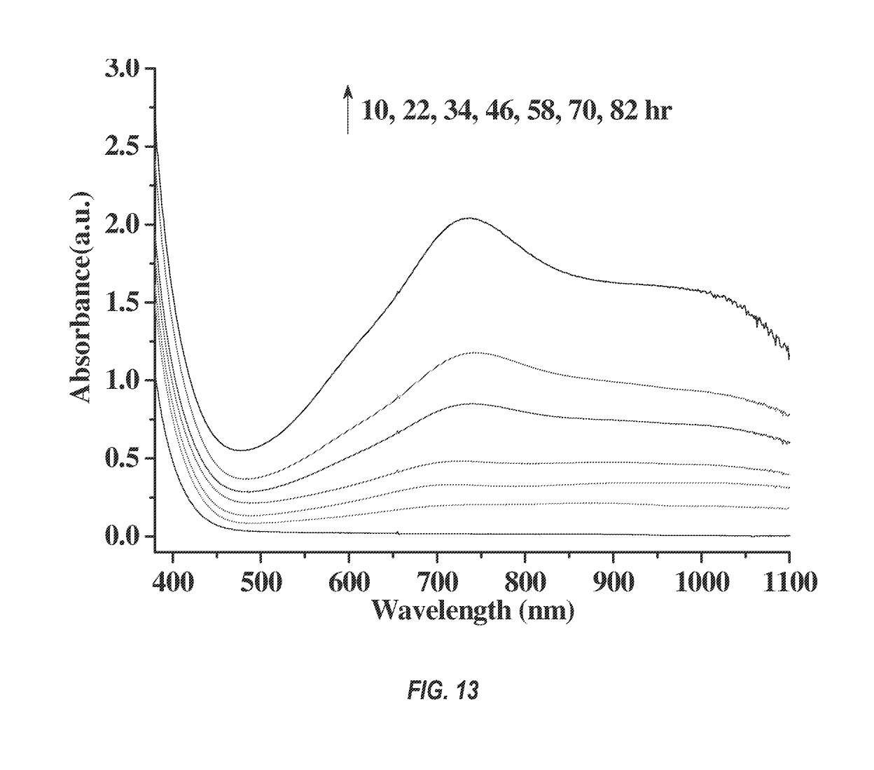

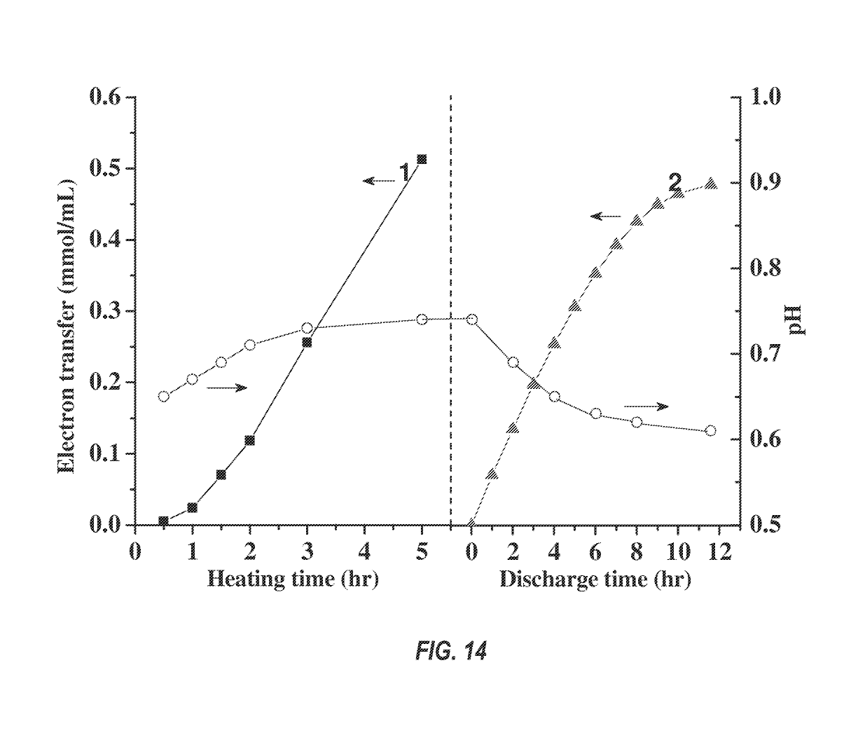

Electron transfer in the starch-PMo₁₂ system with photochromic or thermal degradation was previously investigated, as shown in FIG. 13 curve-1 and FIG. 14 curve-1. Results show that the total amounts of electrons stored in reduced PMo₁₂ solution are 0.412 mmol e⁻/mL and 0.525 mmol e⁻/mL during photochromic and thermal degradation respectively, which is equal to 1.23 and 2.13 electrons per Keggin unit for photochromic and thermal degradation respectively.

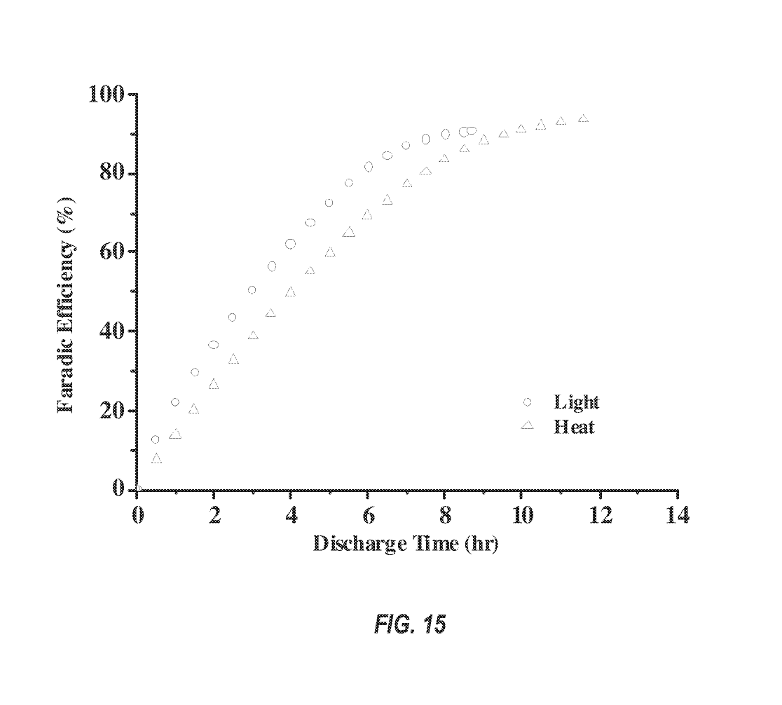

In the experiments described below, experimental single-POM fuel cells achieved a Faradic efficiency as high as 91% and 94% in the discharge of starch-PMo₁₂ system for photo reduction and thermal reduction, respectively (FIG. 15).

### Light Sensitivity and Heat Sensitivity

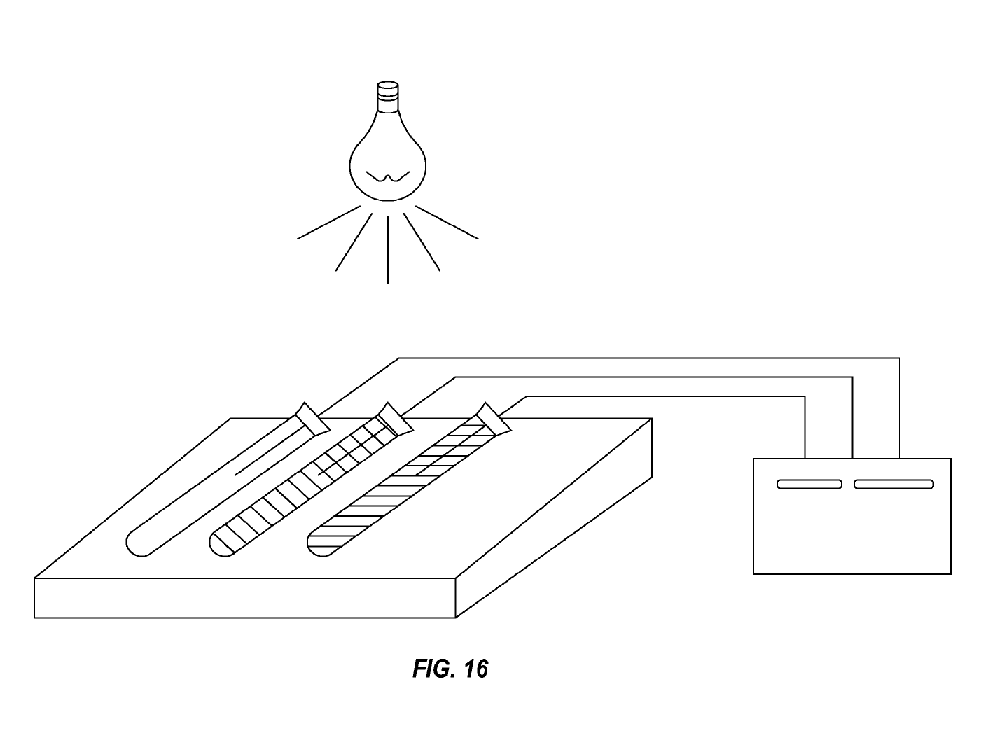

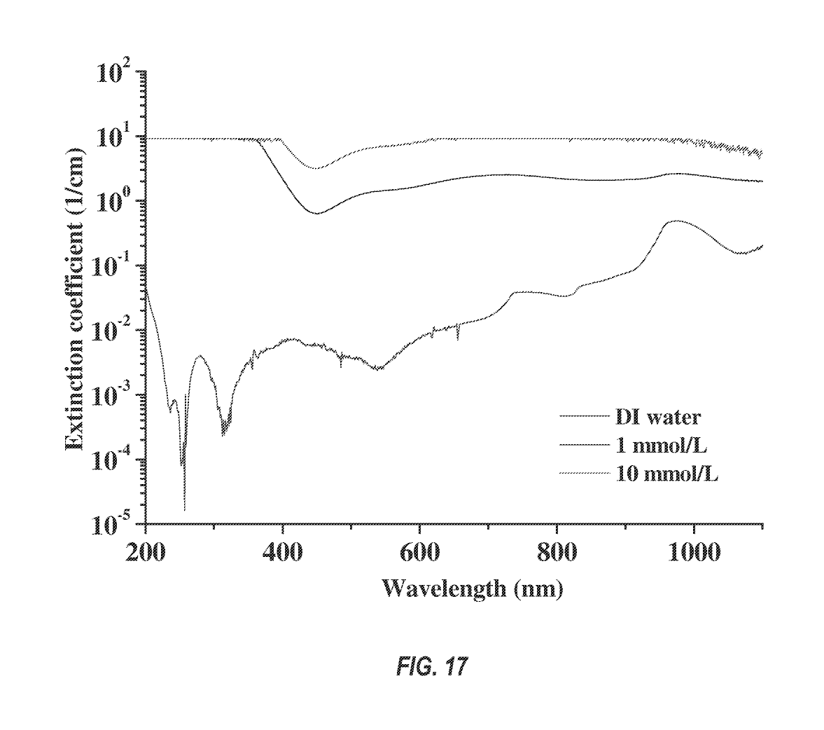

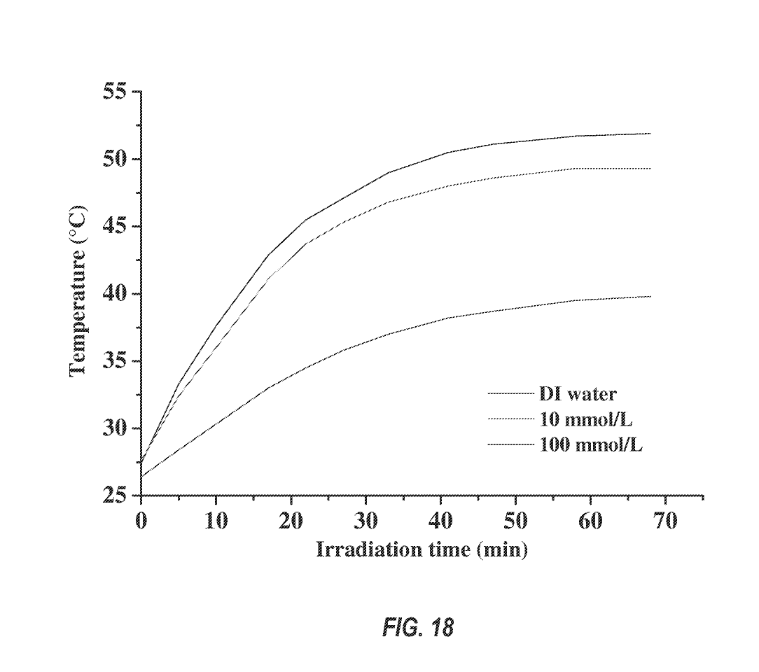

In a series of experiments, the light sensitivity and heat sensitivity of the redox process of POM-starch solutions were investigated. Molybdenum blue, created when PMo₁₂ is reduced, can strongly absorb visible to near infrared light (700 nm to 1000 nm). This is caused by the inter-valence charge transfer (IVCT) transitions. The long wavelength light absorption leads to the conversion of light energy to thermal energy, which raises the solution temperature. An experiment was conducted to test this effect. Three test tubes were prepared, one containing a solution of 1 mmol/L PMo₁₂, one containing a solution of 10 mmol/L PMo₁₂, and one containing deionized water. Each test tube was 10 mm in diameter, and 175 mm long. The experimental apparatus is depicted in FIG. 16 The characteristic absorption of each was measured with a spectrophotometer. FIG. 17 documents the results, showing the larger extinction coefficient than deionized water, and thus greater absorbance across all measured wavelengths. Next, all three were placed under a 50 W SoLux® Solar Simulator, and exposed to simulated sunlight with an energy density of 100 mW/cm². The temperature of each was measured with a thermocouple for 70 minutes. FIG. 18 documents the results, showing that both PMo₁₂ solutions reached a greater temperature than deonized water.

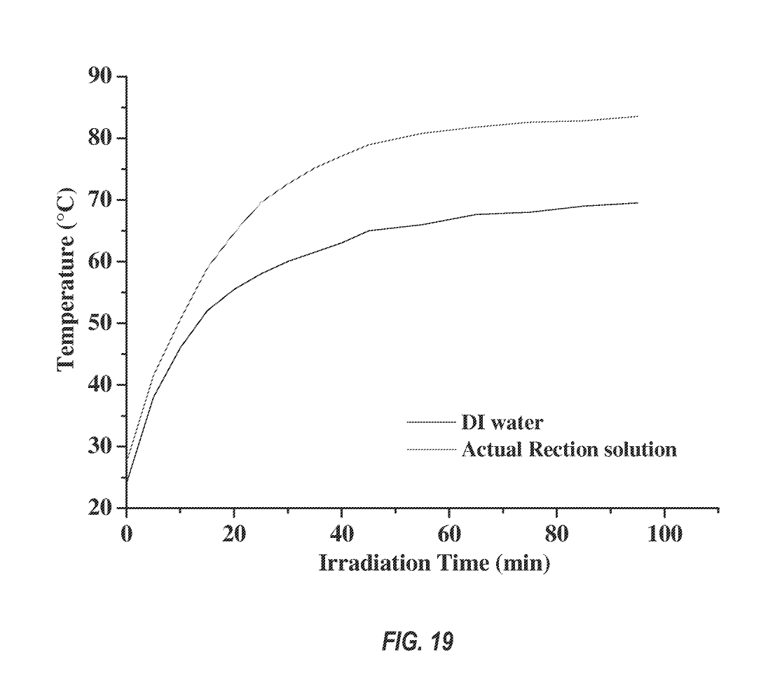

As shown in FIG. 19, the temperature of the starch-PMo₁₂ reaction solution used in the following experiments can reach up to 84° C. under actual sunlight illumination (clear sky, 28° C., Atlanta, Ga., USA) for 90 min. This is 20.8% higher than the maximum temperature reached by deionized water exposed to the same sunlight conditions. POMs are known to harvest electrons and protons from organic matter by heating without illumination. Therefore, the redox reactions between starch and PMo₁₂ can be further enhanced by heating.

A series of experiments were conducted to test the light and heat sensitivity of the starch-PMo₁₂ solution, which are described below. The first experiment tested the light sensitivity of the starch-PMo₁₂ solution by exposing a starch-PMo₁₂ solution to simulated sunlight, while maintaining the solution at a constant temperature. The second experiment tested the heat sensitivity of the starch-PMo₁₂ solution by heating a starch-PMo₁₂ solution to an elevated temperature in a dark environment. The results suggest that the biomass-POM reaction system could combine photochemical and thermal biomass degradation in a single process, which means that the sunlight utilization could be extended to the near-infrared band.

### Monitoring Reaction Degree

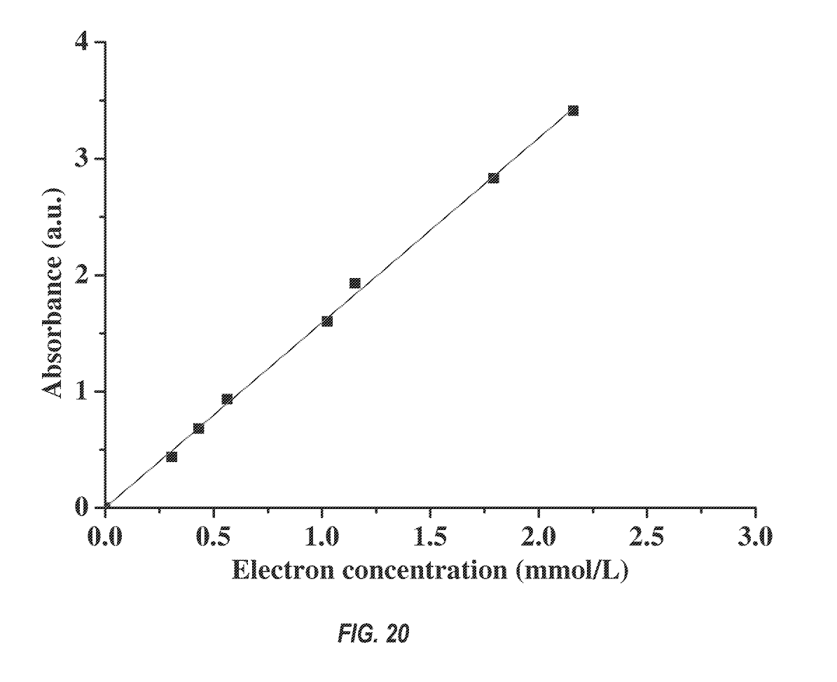

In these experiments, the number of electrons transferred from starch to PMo₁₂ was measured by monitoring the absorption of light at a particular wavelength. As the concentration of Mo⁵⁺ in the starch-PMo₁₂ reaction solution increases, the absorption of 750 nm light increases linearly. To determine an equation for this relationship, a solution containing 1 mmol/L of PMo₁₂, without any added biomass, was reduced by electrochemical reduction treatment at 3V for a variety of time intervals. For each sample that had been reduced for a given time interval, the absorption of 750 nm light was measured with an AGILENT TECHNOLOGIES® 8453 UV-Visible Spectrophotometer. To determine the actual reduction degree of PMo₁₂, the samples were titrated with potassium permanganate solution. The resulting absorptions and reduction degrees are plotted in FIG. 20. From this data, the reduction degree can be determined from absorption using the best-fit slope of the relationship between absorbance (in a.u.) and electron concentration (in mmol/L) is given by the equation y=4.08326x10-4+1.58874x (Adjusted r² value of 0.99826), where y is absorbance and x is electron concentration. To make the measurements during the following experiments, a sample of the experimental solution was taken, and diluted until the sample contained only 1 mmol/L of PMo₁₂. Once diluted, the sample was analyzed with the Spectrophotometer, and the reduction degree calculated.

### Fuel Solution

For the fuel solution, a starch-PMo₁₂ solution was mixed, consisting of phosphomolybdic acid, potato starch, and phosphoric acid. The phosphomolybdic acid (H₃[PMo₁₂O₄₀], PMo₁₂) with an α-Keggin structure was acquired from TCI America. Potato starch solution was obtained by cooking starch suspension for 20 min at 95° C. to obtain a 4% by weight potato starch solution. The fuel solution was then prepared by combining the PMo₁₂ and potato starch solution in water, where the solution had a PMo₁₂ concentration of 0.3 mol/L, and a potato starch concentration of 15 g/L. The starting pH of the solution was then adjusted to 0.3 by adding phosphoric acid (85% aqueous solution, from ALFA AESAR®), resulting in a clear yellow solution.

### Light Sensitivity Test

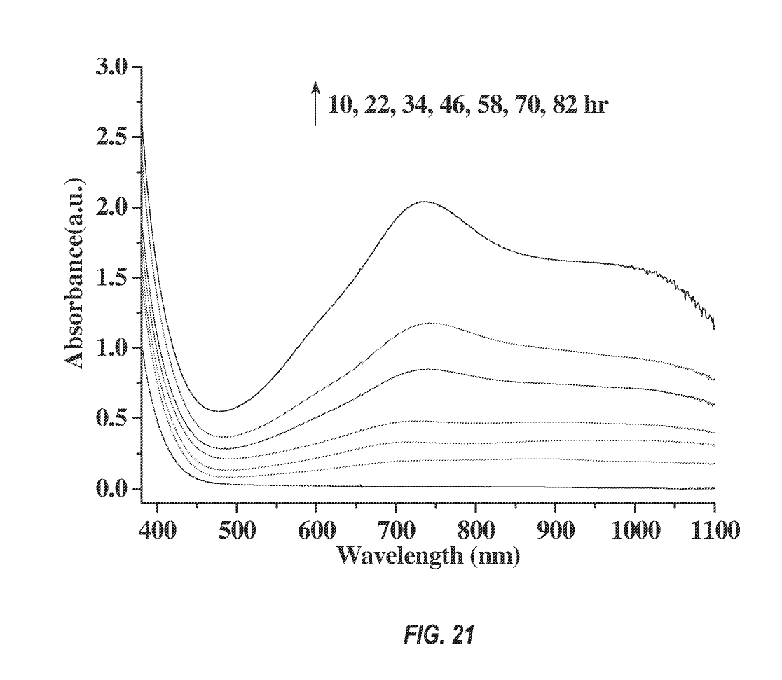

To test the light sensitivity of the redox reaction, the starch-PMo₁₂ solution was kept at a constant temperature of 25° C. by a recirculating water bath (RM6 Lauda, Brinkmann Instruments Service, Inc.). The solution was then exposed to AM1.5-type simulated sunlight, provided by a 50 W SoLux Solar Simulator for a period of time at a distance of 10 cm from the solution surface. For this experiment, the starch-PMo₁₂ solution we used was placed in a clear, transparent glass beaker, with the top open to air. The starch-PMo₁₂ solution gradually changes color from the initial yellow to deep blue, which indicates the reduction of PMo₁₂. FIG. 21 shows the absorbance of the solution as a function of wavelength at different irradiation times, showing increased absorption as the solution changes color. At regular intervals, a very small amount solution was taken out as a sample for analysis of the concentration of reduced PMo₁₂ and the pH of the solution. The results are plotted in FIG. 13, in the curve labeled 1. It can be seen that the electron transfer rate continuously increased during the light irradiation period. After 80 hours, 0.41 mmol electrons were transferred from starch to PMo₁₂ per mL solution, which equals 1.23 electrons obtained per Keggin unit.

Under light irradiation, the oxidation of starch by PMo₁₂ degraded the starch into low molecular weight segments, which can improve reaction kinetics in repeated experiments. This is because POM is not only a strong photo-oxidizing agent but also a strong Brønsted acid. Meanwhile, a slight increase in pH of the reaction solution during this photo-redox period was observed as shown in FIG. 13. The addition of electrons decreases the acidity of the POM, and is accompanied by protonation. Therefore, POM acts as an electron and proton carrier during the photo degradation of starch.

### Heat Sensitivity Test

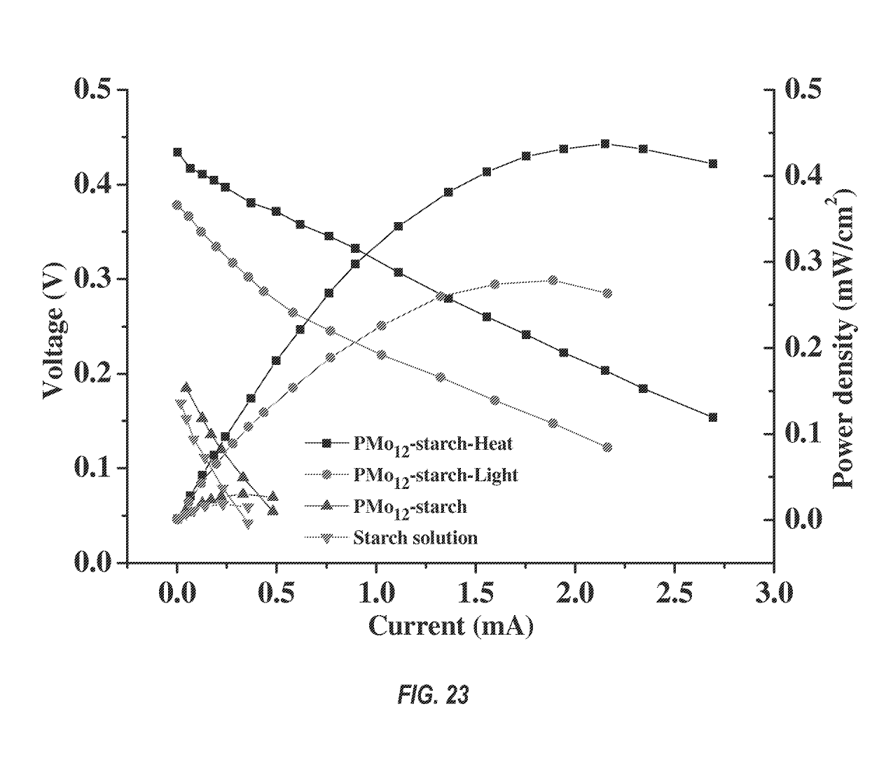

In an experiment to test the heat sensitivity of the starch-PMo₁₂ solution, the mixture was heated and kept at 95° C. for 6 hours without light irradiation. The starch-PMo₁₂ solution used to test the heating effect was modified from the starch-PMo₁₂ solution used in the simulated sunlight test above. Here, the solution was prepared of 15 g/L potato starch (prepared as above), and 0.25 mol/L PMo₁₂. The pH was adjusted to 0.65 by adding phosphoric acid. The transfer of electrons and change in pH of the solution during the thermal-reduction experiment are shown in FIG. 13, which suggest that 0.525 mmol electrons were transferred from starch to PMo₁₂ per mL solution by thermal degradation alone (equal to 2.13 electrons per Keggin unit). The light absorbance of the heat-reduced starch-PMo₁₂ solution also increased, as shown in FIG. 23. The pH value increased from 0.65 to 0.74. The results suggest that the designed biomass-POM reaction system could combine photochemical and thermal biomass degradation in a single process, which means that the sunlight utilization could be extended to the near-infrared band.

### Fuel Cell Used—Experimental Methods

Following these experiments, the heat- and light-reacted starch-PMo₁₂ solutions were then used to generate electricity in a fuel cell, shown in FIG. 2. The fuel cell used a commercially-available membrane electrode assembly, purchased from Fuelcells Etc., of College Station, Tex., US. The electrolyte used was a membrane composed of NAFION® 117. The anode electrode consisted of five layers of carbon cloth on one side of the membrane. The cathode electrode consisted of five layers of carbon cloth impregnated with 60% Pt/C catalyst, loaded at 5 mg/cm². The Pt/C catalyst consisted of crystals between 4.0-5.5 nm, and the specific surface area of the crystals was about 60 m²/g. The bipolar plates of the cell were made of high-density graphite plates with a straight flow channel 2 mm wide, 2 mm deep, and 5 cm long (a total active area of 1 cm²). The MEA was sandwiched between two graphite flow-field plates, which were clamped between two acrylic plastic end plates. Rubber gaskets were included on the circumference of the graphite flow-field plates to prevent any leakage. In the experiment, the starch-PMo₁₂ solution reduced to molybdenum blue was pumped through the anode reaction cell, and oxygen was flowed through the cathode cell using a compressed oxygen cylinder. The temperature of the liquid in the cell was about 25° C. (room temperature). The solution flow rate through the anode graphite plate was 12 mL/min and the oxygen flow rate through the cathode was 75 mL/min at 1 atm. A DS345 30 MHz (Stanford Research Systems) and a 4200-SCS (Semiconductor characterization system, Keithley Instruments Inc.) were used to examine the I-V curves using the controlled potentiostatic method.

### Control—No Heat or POM

Four solutions were used to power the fuel cell: a pure starch solution, an untreated starch-PMo₁₂ and the heat- and light-treated solutions prepared in the previous experiments. The results of these runs are shown in FIG. 23. As a control, a pure starch solution (2.5% by weight) was provided to the anode side of the fuel cell, and oxygen supplied to the cathode side of the fuel cell. The power provided by the fuel cell was very small because of the unavailability of a catalyst to electro-oxidize the starch. When PMo₁₂ was added without sunlight irradiation, the power output still did not improve because the redox reaction between PMo₁₂ and starch could not take place at room temperature without light irradiation. PMo₁₂ in its original oxidation state generally cannot oxidize starch in the hybrid cell at room temperature without irradiation.

### Treated Samples

Next, the simulated-sunlight treated starch-PMo₁₂ solution was used to fuel the fuel cell. FIG. 13, in the curve labeled 2, shows the number of discharged electrons, calculated by integrating the electric current output curve. The number of electrons discharged on the electrode was 0.375 mmol electrons per mL solution, which is close to the calculated number shown in curve 1. This indicates that the electrons stored in the reduced PMo₁₂ were almost completely transferred to the cathode via the external circuit and captured by O₂. After discharging, the pH was almost recovered to the original value because the oxidation of the reduced POM led to the release of protons from the POM to the solution. Finally, the heat-treated starch-PMo₁₂ solution was used to fuel the fuel cell. FIG. 13 shows the number of discharged electrons, calculated by integrating the electric current output curve.

### Cycling Light Sensitivity

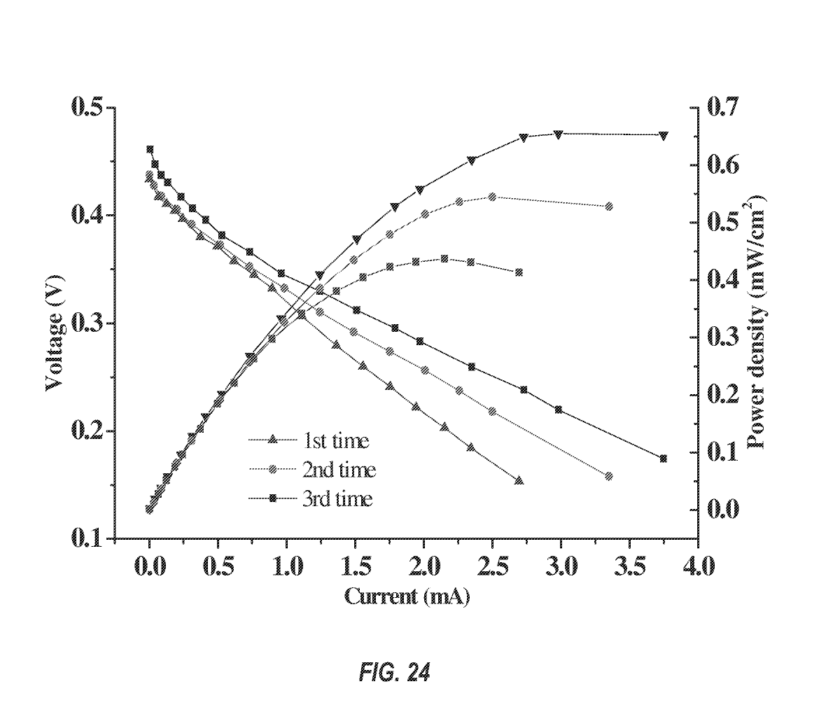

An experiment was conducted to test whether the light-sensitivity of the reduced starch-PMo₁₂ was repeatable. After the photo-irradiated solution was fully discharged, the solution contained excess unreacted starch and its various derivatives, which was then exposed to simulated solar light followed by discharging again. In each cycle, the discharged fuel-PMo₁₂ solution was exposed to AM-1.5 simulated sunlight and kept at constant 25° C. until use. The solution was then pumped into the anode of the fuel cell to electrically discharge for several hours over a load of 1.6Ω resistance until the current fell below 0.1 mA. The photo-irradiation-discharge cycles were repeated three times and the power outputs were measured, as illustrated in FIG. 24. The output power density increased with the number of repeated cycles. A power density of 0.65 mW/cm² was reached on the third cycle, even though no extra starch or PMo₁₂ was added. The increase in the power density may be due to the decrease in the starch molecular weight during the repeated tests. The low molecular weight species from oxidation and acid hydrolysis reduced the solution viscosity and increased the reaction rate with POM molecules, as compared to high molecular weight starch.

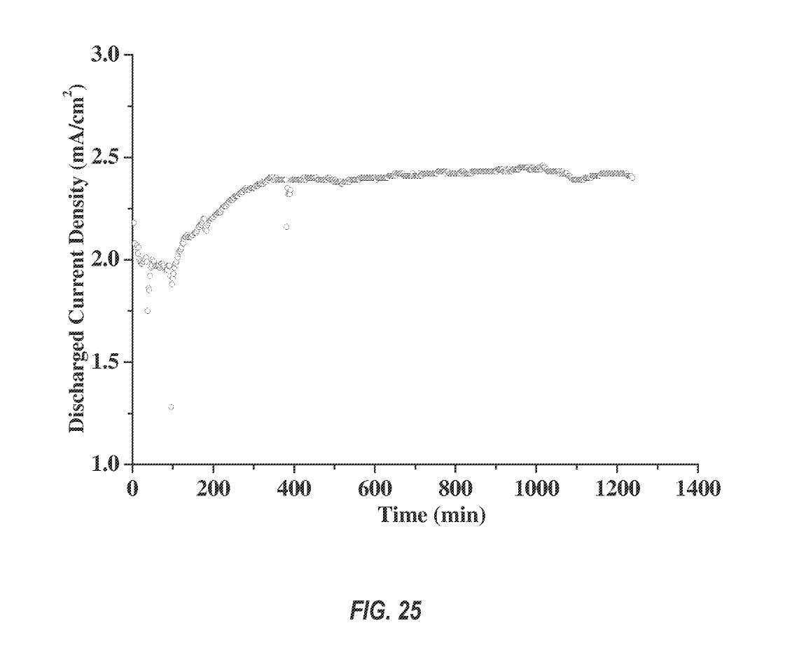

Different from the pre-light irradiation or pre-heating tests conducted above, a continuous experiment with in-situ light irradiation while producing electricity was also conducted. In the continuous experiments, the transparent glass vessel was placed under irradiation of AM 1.5-type simulated sunlight and heated to 95° C. during a continuous discharge experiment. The glass (sodium lime glass) was 2 mm thick, with transmission >95% for wavelengths from 320 to 1100 nm and transmission >80% for wavelengths from 270 to 320 nm (air as blank sample, measured on AGILENT TECHNOLOGIES® 8453 UV-Visible Spectrophotometer). The reaction solution was placed under simulated sunlight irradiation and heated while being discharged simultaneously. The cell worked continuously for almost 20 hours at a steady current density up to 2.5 mA/cm², as shown in FIG. 25. Both repeated cycle tests and in-situ continuous experiments indicate that the POM catalyst can be reused without further treatment.

### Different Biomasses

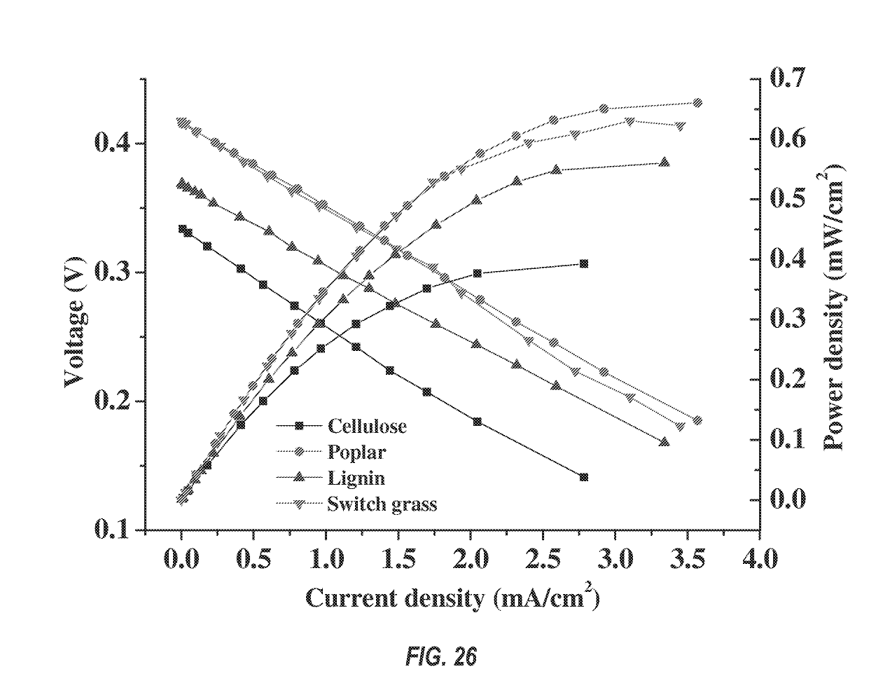

An experiment was conducted to test a variety of biomasses were used to fuel an exemplary fuel cell. Cellulose, lignin, switchgrass, and poplar powder were all tested. Crystalline cellulose was purchased from Alfa Aesar. The cellulose suspension was homogenized for 40 min to form a small particle suspension in the solution before used. Lignin was isolated from a commercial USA softwood Kraft pulping liquor. Switchgrass was from Ceres, Inc. (Thousand Oaks, Calif.), and poplar was provided by Michigan State University. These samples were washed with DI water and then dried at 45° C. overnight. The dry samples were then milled in a Wiley mill through a 0.8 mm screen, yielding the biomass powder directly used in this example without any pretreatment. FIG. 26 shows the power density that was produced by cellulose, lignin, switchgrass, and poplar powder. The power density of our solar-induced hybrid fuel cell can reach 0.65 and 0.62 mW/cm² when fueled by poplar and switchgrass powders, respectively. All these materials are water insoluble, so they were particle suspensions at the beginning, but the biomass particles were degraded and dissolved in the reaction solution as time progressed. The results illustrate that all these biomass materials can be directly used as fuel in this solar-induced hybrid fuel cell with POM as catalyst and charge carrier.

### Metal Ions as Accelerants

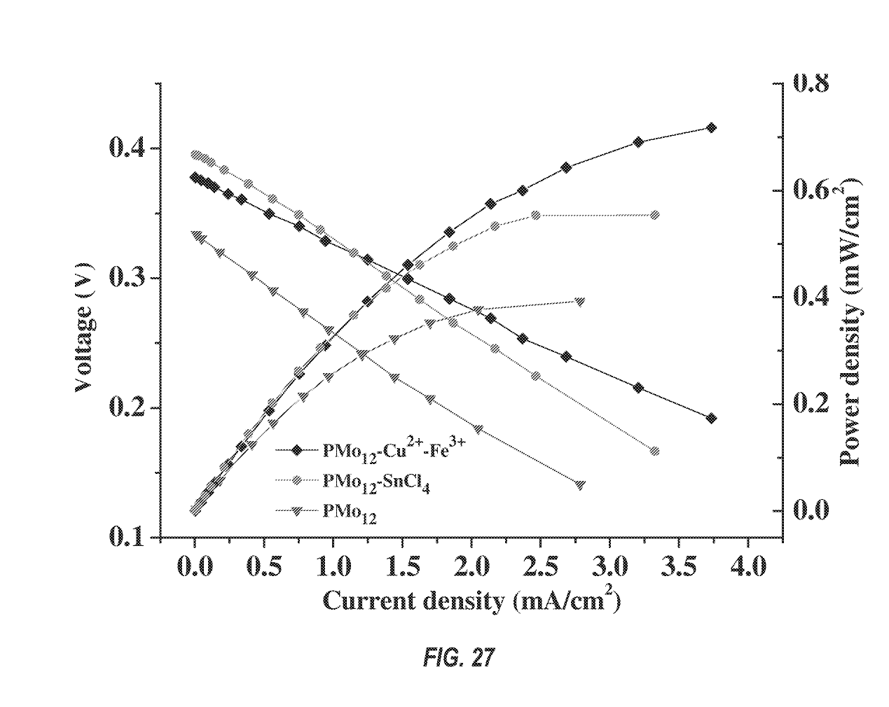

A fifth experiment was conducted to examine the effects of adding metal ions to the biomass solution. The power density produced by crystalline cellulose was lower than that obtained from starch solution under similar conditions, probably because of the slow hydrolysis of cellulose crystals. As discussed above, some metal ions, such as Sn⁴⁺, Fe³⁺ and Cu²⁺ etc., could function as Lewis acids to help cleave glycosidic bonds in, among other biomasses, cellulose. In these experiments, the reaction solutions consisted of 0.25 mol/L PMo₁₂ and 0.1 g biomass with a total solution volume of 20 mL and pH 0.5. The solution was irradiated by simulated sunlight (100 mW/cm²) and heated on a hotplate up to 95° C. and kept for 6 hours (photo-thermal experiment). The discharge condition was the same as the starch-PMo₁₂ system. To improve the reduction degree of PMo₁₂ in cellulose-PMo₁₂ reaction system, some metal salts as Lewis acids were added. The Lewis acids used in this example include SnCl₄ (Alfa Aesar, 0.188 mol/L) and Fe³⁺-Cu²⁺ (Fe₂(SO₄)₃, Alfa Aesar, 0.15 mol/L; CuSO₄, Alfa Aesar, 0.15 mol/L). Consequently, as shown in FIG. 27, when these promoters were used in this system, the power density increased, even up to 0.72 mW/cm² (Cu²⁺-Fe³⁺ as promoters for PMo₁₂), which is almost 100 times higher than that of cellulose-based microbial fuel cells reported in literature.

### POM-I Preparation and Reduction Rate Experiment.

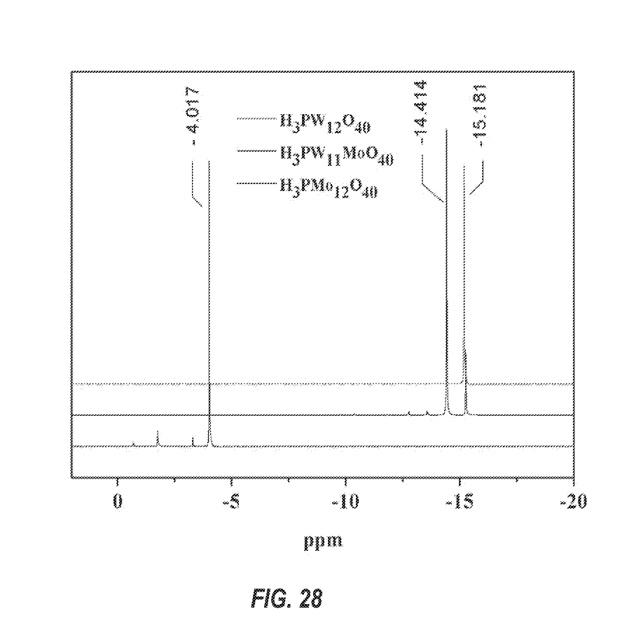

To investigate the functional mechanisms of a two-POM fuel cell, a series of experiments were conducted. A POM-I polyoxometalate, having the formula H₃PW₁₁MoO₄₀, was synthesized by refluxing a solution of mixed phosphomolybdic acid (H₃[PMo₁₂O₄₀]) and phosphotungstic acid (H₃[PW₁₂O₄₀]) with a mole ratio of 1:11 for 1 hour. Then, water was evaporated in air at 80° C. until the concentration of acid in the solution reached 0.3 mol/L. The structure of the synthesized POM-I was verified by ³²P NMR, as shown in FIG. 28.

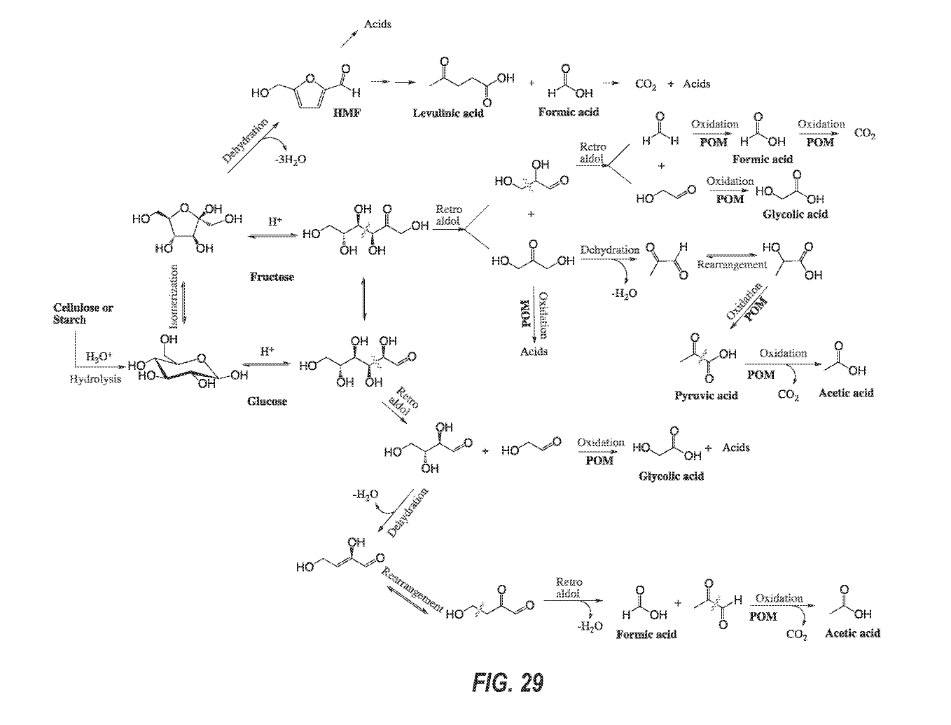

A set of experiments was designed to test the redox reaction between biomasses and the prepared POM-I solution. Glucose was used as a model compound in these experiments. A glucose-POM-I mixture was prepared, with 0.3 mol/L POM-I, and 2 mol/L glucose. A proposed reaction pathway is given in FIG. 29. As with the experiments above, the reduction degree of POM-I was measured by spectrophotometry. Here, reduction degree (m) is represented by the formula:

$$m = \frac{\sum ( [ {Mo}^{5 +} ] + [ {W}^{5 +} ] )}{[ POM \text{-} I ]} \qquad ( 7 )$$

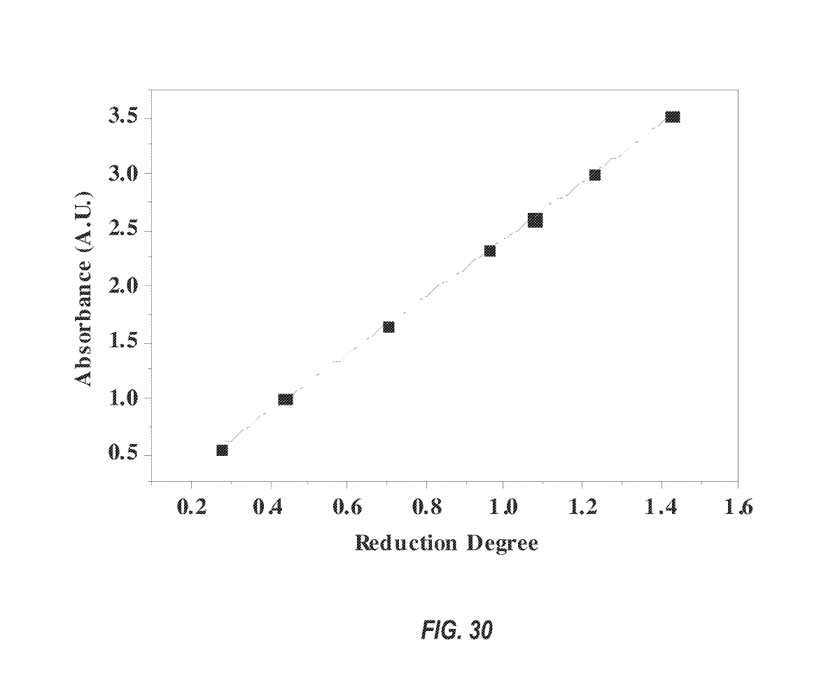

To obtain a calibration curve, correlating reduction degree to absorbance, pure POM-I solution at a concentration of 50 mmol/L, without glucose, was reduced by electrochemical reduction at 3V for a variety of time intervals. For each time interval, the absorbance was measured with an Agilent Technologies 8453 UV-Visible Spectrophotometer, and the reduction degree determined by titration with potassium permanganate solution. The results are plotted in FIG. 30, and reveal a calibration curve of y=2.551x-0.129, where X is reduction degree, and Y is absorbance (in a.u.).

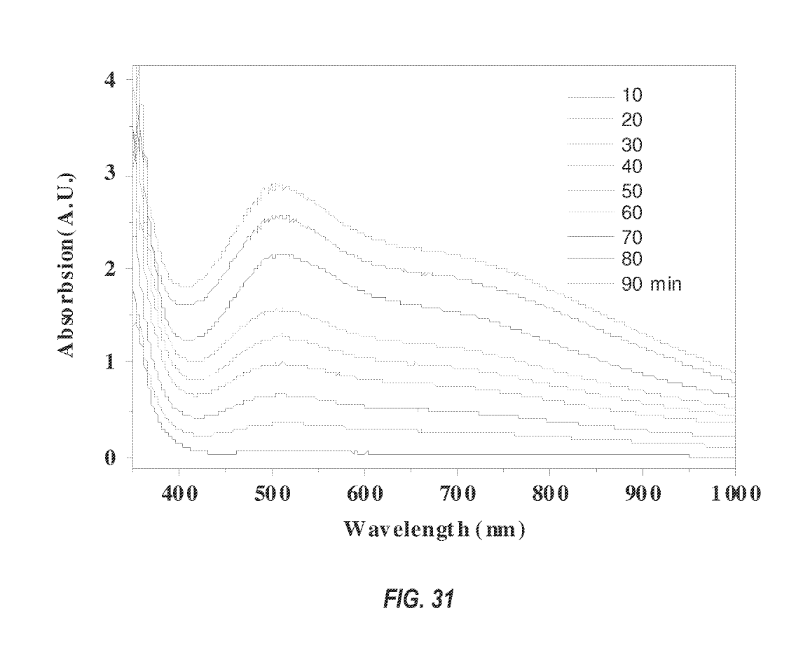

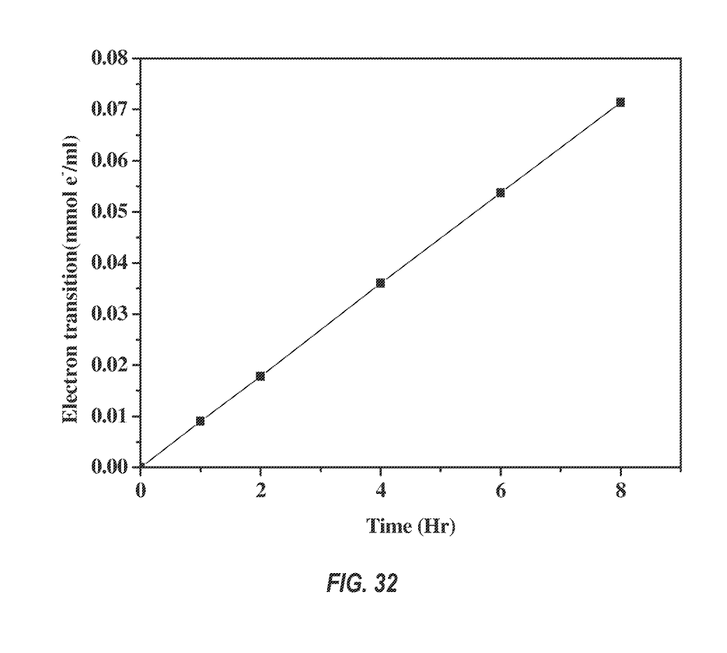

To test the reduction of the glucose-POM-I solution by illumination, a 25 ml sample was placed in a glass vessel and illuminated with AM 1.5-type simulated sunlight from a 50 W SoLux Solar Simulator for 8 hours at a distance of 10 cm from the reactor surface. The color of the solution gradually turned from yellow to purple as the POM-I was reduced, increasing the absorbance of the solution, as shown in FIG. 31. At various time intervals, a sample of the reducing solution was taken, diluted to 50 mmol/L of POM-I, and analyzed with the photospectrometer. The results of each of these measurements is shown in FIG. 32.

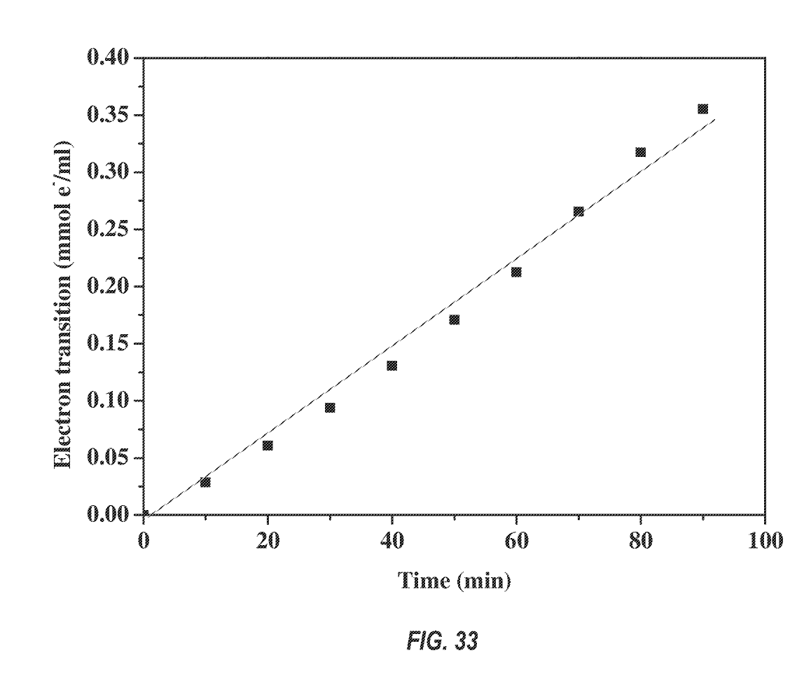

To test the reduction of the glucose-POM-I solution by heating, a 25 ml sample was placed in a glass vessel and heated to 100° C. in the dark for 90 minutes. Samples were taken at similar intervals and the same method as the illumination experiment. The results of these measurements is shown in FIG. 33.

### POM-II Formulation and Oxidation Experiment

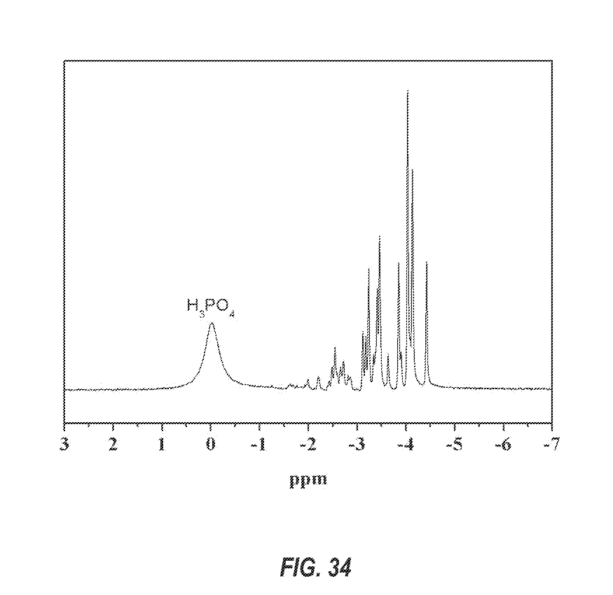

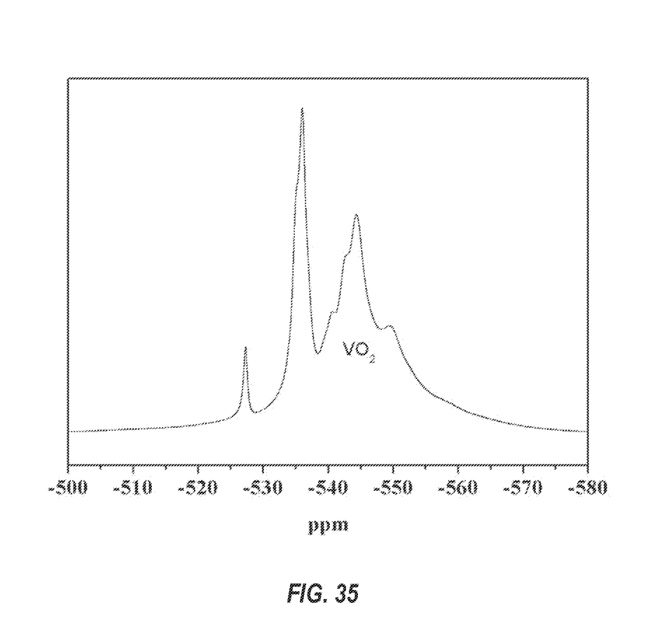

A POM-II polyoxometalate, having the formula H₁₂P₃Mo₁₈V₇O₈₅, was synthesized by the process described in V. F. Odyakov et al., Applied Catalysis A: General 342, 126-130 (2008), the entirety of which is hereby incorporated by reference as if fully set forth herein. A first solution was prepared by adding 0.079 mol (14.32 g) V₂O₅ to 600 ml cooled deionized water (˜4° C.). 90 ml H₂O₂ was added with magnetic stirring, and cooled by ice. After the V₂O₅ was dissolved, 0.02 mol (2.3 g) of H₃PO₄ (85% by weight) was added, and stirred at room temperature for two hours, allowing the extra H₂O₂ to decompose. A second solution was prepared by adding 0.81 mol (116.64 g) MoO₃ and 0.095 mol (10.96 g) H₃PO₄ (85% by weight) to 1 L of boiling deionized water. After the second solution turned yellow, the first solution was gradually added to the second solution. This process was performed by pouring 200 ml of the first solution into the second, then returning the solution to a boil, and repeating until all of the first solution was consumed. The combined solution was boiled until MoO₃ dissolved completely, and then further evaporated to a volume of 150 ml. This resulted in a concentration of POM-II solution of 0.3 mol/L. The results of the synthesis were confirmed by ³¹P and ⁵¹V NMR spectral analysis, shown in FIG. 34 and FIG. 35, respectively.

Sodium salts of the POM-II solution were then synthesized by neutralization of the heteropoly acid POM-II with sodium carbonate (Aldrich). By controlling the mole ratio of POM-II and Na₂CO₃, 2 Na, 3 Na, 4 Na, and 6 Na substitute POM-II were prepared.

The concentration of synthesized POM-II solution was determined by gravimetric analysis. 0.2 ml of solution was transferred to a 10 ml beaker that had been dried at 120° C. to constant weight previously. Then the solution was dried at 120° C. for constant weight.

The reduction degree of POM-II was determined by potentiometric titration with 5 mmol/L potassium permanganate solution (calibrated by standard sodium oxalate). The titration was conducted in 1M phosphoric acid solution at room temperature using an Ag/AgCl reference electrode (BASi) and a Pt wire electrode. The reduction degree was given by the formula:

$$m = \frac{\sum ( [ {V}^{3 +} ] )}{[ POM \text{-} II ]} \qquad ( 8 )$$

An experiment was conducted to determine the oxygen oxidation rate of POM-II. A 10 ml sample of POM-II was reduced by electrochemical reduction treatment at 3V for varying times. An initial reduction rate mₒ was determined. The solution was then transferred to a glass flask with an airtight stopper, and connected to a compressed oxygen cylinder. The flask was heated, kept at a constant temperature of 80° C., and vigorously shaken by a Burrell wrist-action shaker. At regular intervals, 0.2 ml of solution was removed an analyzed to determine the reduction degree. The amount of electrons transferred from reduced POM-II to oxygen (Aᵢ) can be calculated by:

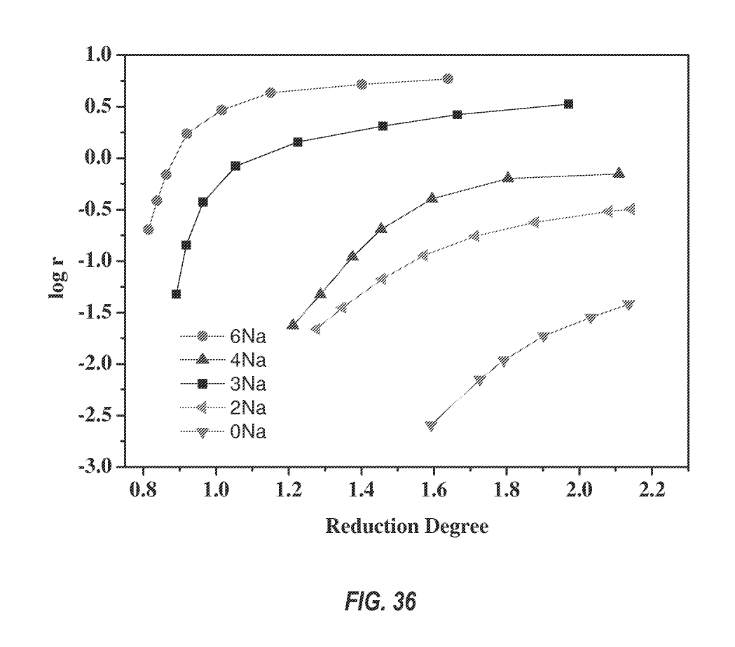

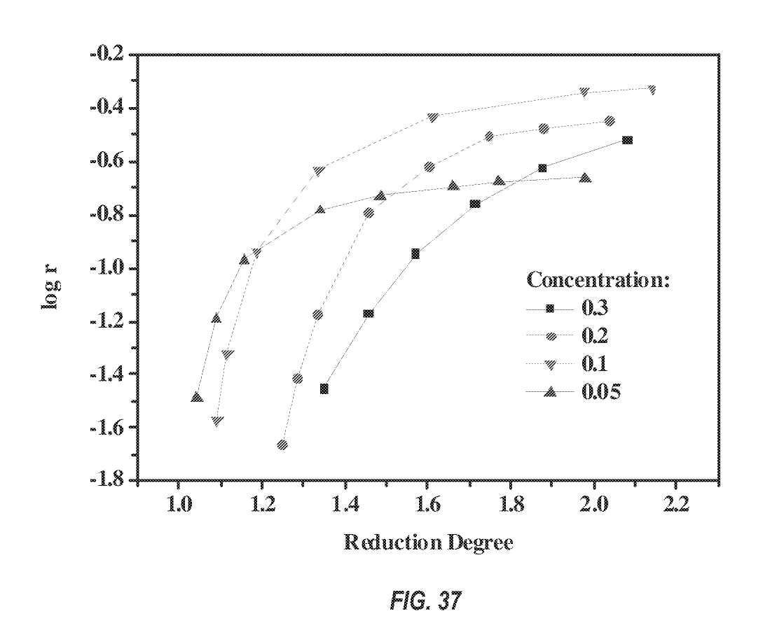

Aᵢ=(mᵢ−mₒ)*c*v (9)

Where mᵢ is the reduction degree at a given interval, c is the concentration of POM-II solution, and v is the volume of the POM-II solution. By differentiating the function Aᵢ=f(i) the function r=f(m) can be obtained, where r is the reaction rate in mol e⁻/L*h. This experiment was repeated for POM-II concentrations of 0.3, 0.2, 0.1, and 0.05 mol/l POM-II. The results of these experiments are given in FIG. 36. The experiment was repeated for different sodium substituted salts of 2 Na, 3 Na, 4 Na and 6 Na. The results of these experiments are given in FIG. 37.

### Glucose Fuel Experiments

An experimental fuel cell was also constructed to test the POM solutions. The fuel cell consisted of an anode flow plate and electrode, cathode flow plate and electrode, proton exchange membrane, and a load circuit. The flow plates had a serpentine flow channel 2 mm wide, 10 mm deep, and 4 cm long (interface area of 1 cm²). The anode and cathode electrodes were constructed of a graphite felt, purchased from Alfa Aesar. The electrode material was pre-treated in an acid bath of concentrated sulphuric and nitric acids in a 3:1 volumetric ratio at 50° C. for 30 minutes. Following acid treatment, the electrodes were washed with deionized water until the pH of the wash was neutral. The electrode material was then dried at 80° C., and cut into pieces 2 mm wide and 10 mm long. These electrodes were placed on either side of a MEA. The proton exchange membrane was made of NAFION® 115 (127 μm thick). The membrane was pretreated in a boiling solution of 1 mol/L H₂SO₄ (Aldrich) and 3% H₂O₂ (Aldrich) for 30 minutes, then washed and soaked in deionized water.

The POM-I and biomass fuel were stored in a 35 ml glass vessel connected to the anode flow plate of the fuel cell via a PTFE tube and pump. When the pump was turned on, the POM-I and biomass fuel mixture circulate through the anode flow plate at a flow rate of about 30 ml/min, and a temperature of 80° C.

The POM-II solution was stored in a 35 ml glass vessel connected to the cathode flow plate and an oxygen mixing tank via PTFE tubing. The oxygen mixing tank consisted of a straight glass column (1.5 cm diameter, 20 cm long) packed with carbon fibers. The POM-II solution and oxygen gas (from a compressed oxygen cylinder) were introduced into, and mixed in the column.

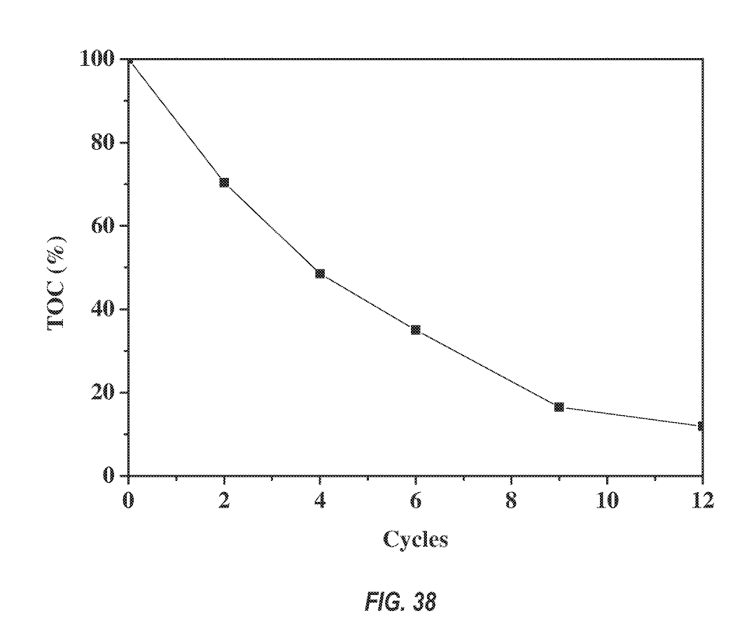

The oxygen mixing tank was maintained at a temperature of 80° C. The POM-II solution was pumped through the oxygen mixing tank at 30 ml/min, and the oxygen was introduced at a 15 ml/min flow rate at a pressure of 1 atm. The regenerated POM-II solution leaving the oxygen mixing tank was then pumped into the cathode flow plate of the fuel cell. As shown by Total Organic Carbon analysis, the glucose broke down with repeated thermal treatment, depicted in FIG. 38.

Both light- and heat-treated glucose-POM-I solutions were tested in the experimental fuel cell. For each test run, a solution consisting of 2 mol/L glucose and 0.3 mol/L POM-I was used. For each trial, the anode electrolyte tank was heated to 100° C. The fuel solution was pumped through the anode flow plate at a rate of about 10 ml/min, at a temperature of about 80° C. The POM-II solution consisted of 30 ml of water containing 0.25 mol/L of 2 Na substituted POM-II salt solution. The POM-II solution was pumped through the oxygen mixing tank at a rate of 15 ml/min, which was maintained at a temperature of 80° C., and 15 ml/min (at 1 atm) of oxygen gas was pumped through it.

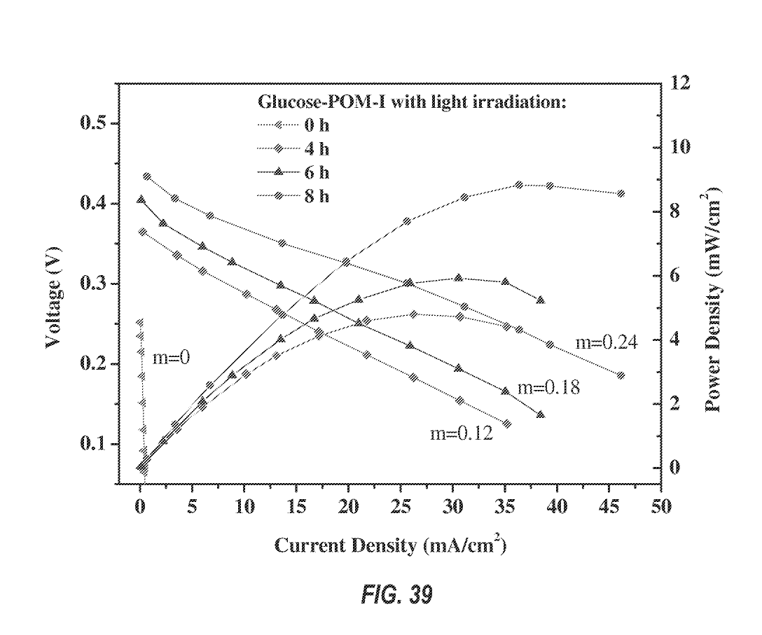

POM can oxidize some organic materials not only by heating but also by light irradiation. Besides simple heating, sunlight induced glucose powered fuel cell with POM catalyst was also studied. FIG. 39 shows that after irradiated with 8 h under simulated sunlight (AM-1.5 simulated sunlight), the reduction degree of POM-I increased up to 0.24 and the power density reaches 8.8 mW/cm². However, when POM-I was mixed with glucose solution without light irradiation, the power output was very low as expected because the POM-I reduction could not occur without light irradiation or thermal heat treatment.

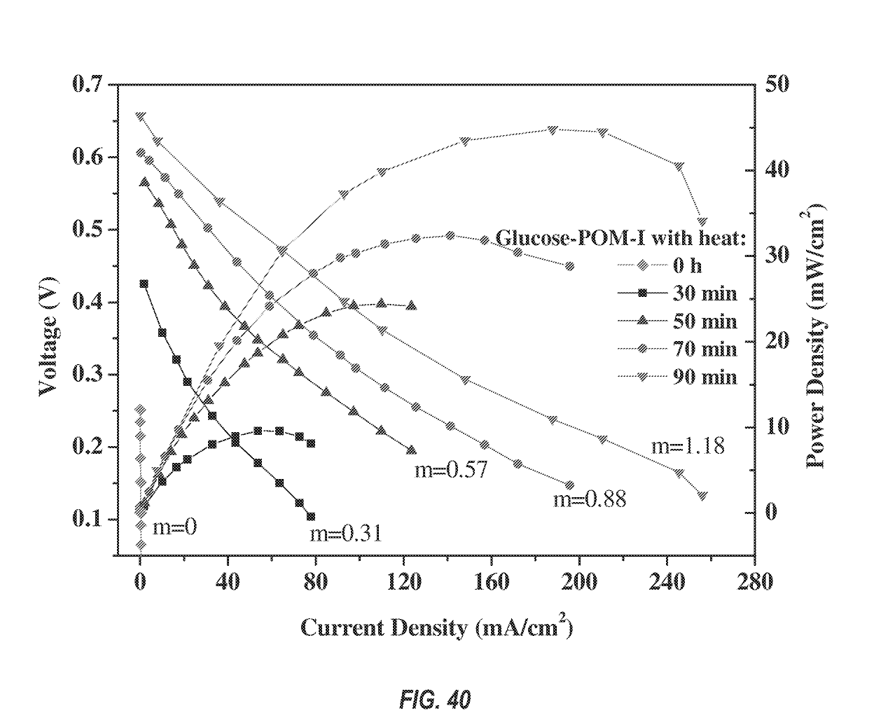

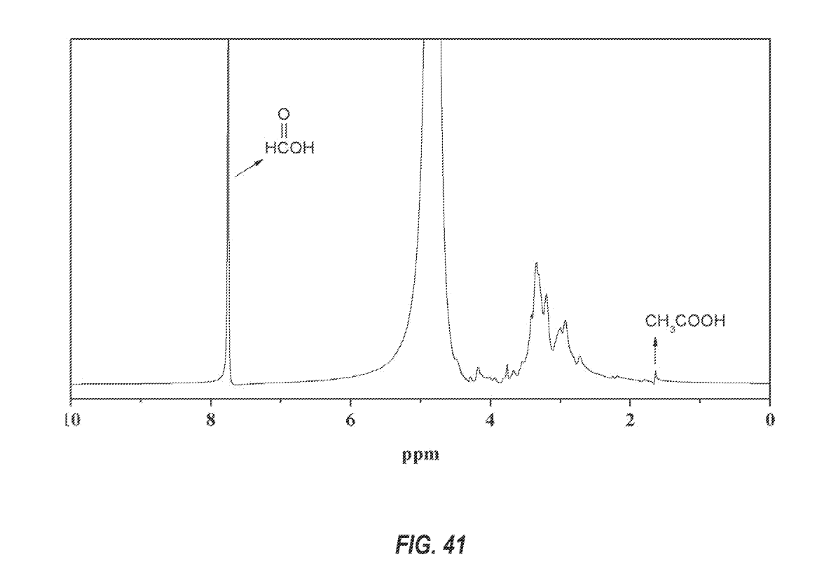

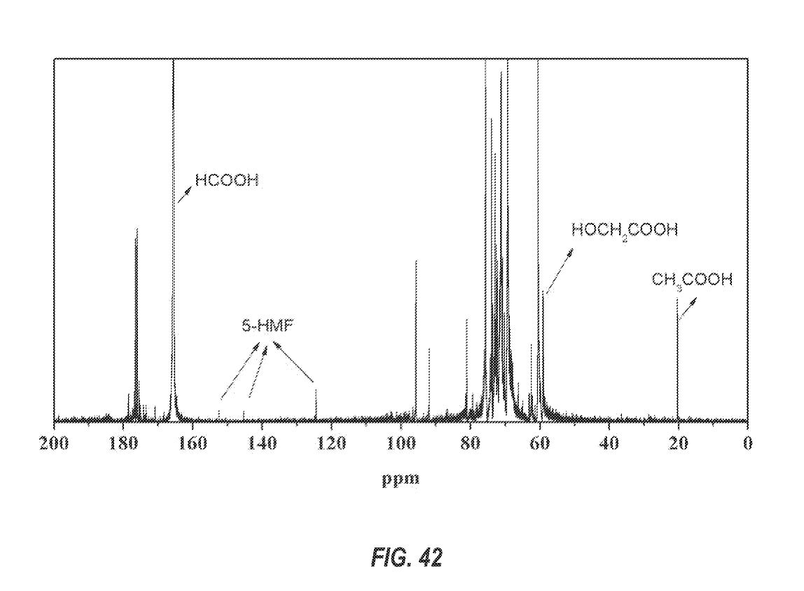

Five trials were run with heat-treated glucose-POM-I, heated to 100° C. for 0, 30, 50, 70, and 90 minutes. The voltage and power density at various current densities is shown in FIG. 40. Four trials were run with light-treated glucose-POM-I, illuminated for 0, 4, 6, and 8 hours. The voltage and power density at various current densities is shown in FIG. 39. The final products of the heat-treated glucose-POM-I were analyzed by ¹H and ¹³C NMR, the results of which are shown in FIG. 41 and FIG. 42, respectively.

### Faradic Efficiency Test

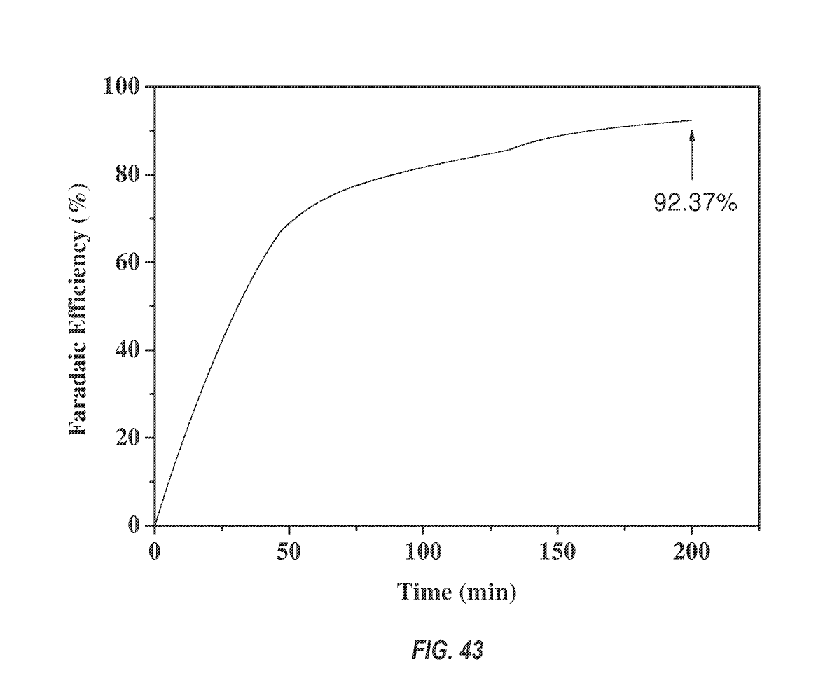

As one of important part of discharge efficiency, Faradic efficiency was investigated during the discharging process of this direct biomass fuel cell. In this experiment, Faradic efficiency was measured by integrating the current discharging at room temperature and comparing it with total electron charge transferred from the biomass to the POM-I in anode solution. This measure indicates the percentage of total electrons released from the biomass in the anode that travels through the load circuit. The results, given in FIG. 43, shows that the Faradic efficiency reaches 92.4%.

To test the Faradic efficiency of the POM-I/POM-II fuel cell, 3 ml of a solution consisting of 2 mol/L glucose and 0.3 mol/L POM-I was preheated to 100° C. for 4 hours. The reduction degree of the POM-I was then measured and recorded via spectrophotometry. The number of electrons transferred from glucose to POM-I could be calculated as m*c*v, where c is the concentration, and v is the volume of POM-I. This pre-treated POM-I solution was then placed in the anode electrolyte tank of the experimental fuel cell. A sample of 20 ml of H-type POM-II solution (0.3 mol/L) was placed in the cathode side of the fuel cell. Both tanks were maintained at room temperature, and in the dark to prevent additional reduction of the anode electrolyte. The glucose-POM-I and POM-II solutions were circulated through the fuel cell, which discharged across a load of 1.6Ω until the current fell below 1 mA. The current was recorded every 1 s. From this data, the Faradic Efficiency C_{F} could be calculated according to the following equation:

Where Q_{Discharging} is the experimental charge quantity calculated from the discharge current-time curve, and Q_{POM} is the maximum possible charge quantity released by 3 ml reduced POM-I, calculated by spectrophotometry. I is the electric current obtained during the discharging process, m is the reduction degree of POM-I, C_{POM} is the concentration of POM-I; V is the volume of POM-I solution; and F is the Faraday constant. The results are depicted in FIG. 43.

### Various Biomass Fuel Tests

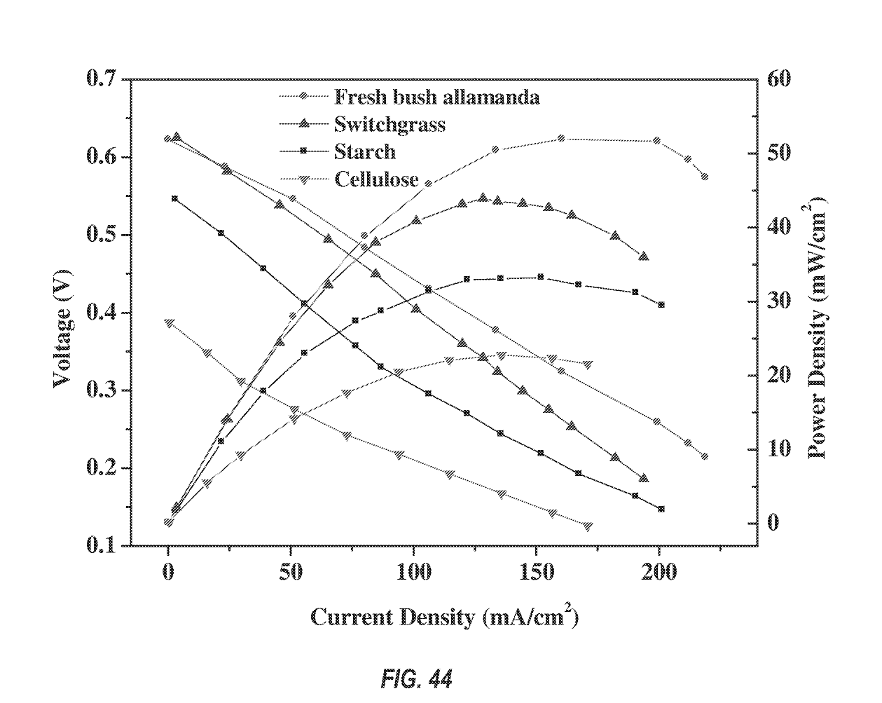

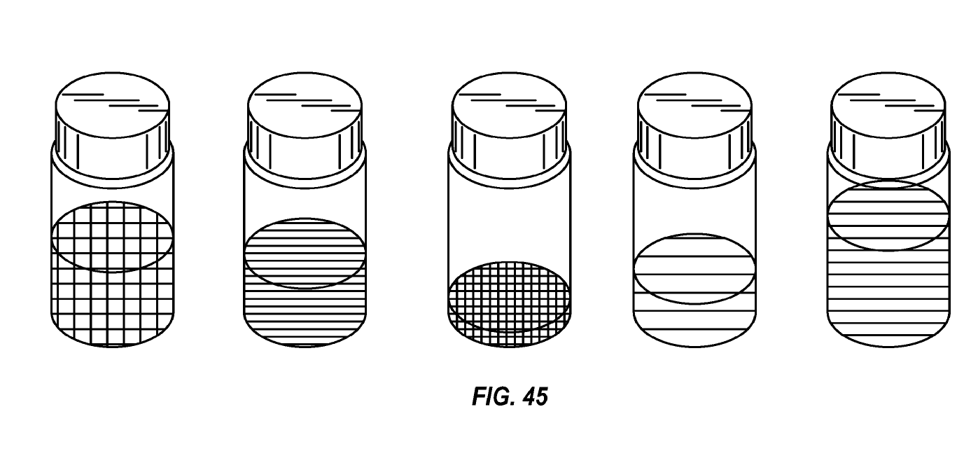

The performances of fuel cell powered by various biomasses are shown in FIG. 44. Experimentally, 0.3 mol/L POM-I solution was mixed with biomass in the anode tank and 0.3 mol/L POM-II solution was filled in the cathode tank. Some biomasses, such as grass powders, were particle suspensions in POM solution at the beginning After preheating of POM-I in the anode tank at 100° C. for 4 hours, the biomass was depolymerized to water-soluble fragments. During this process, the color of POM-I solution changed from yellow to deep purple POM-I solution was reduced (See FIG. 45). The electrolyte solution was readily generating electric current in the fuel cell when the external circuit was connected. As shown in FIG. 44, the power densities were 22 and 34 mW/cm² respectively when cellulose and starch were used as the fuels. Dry switchgrass powder and freshly collected plants (bush allamanda) were also used as the fuels. The power densities even reached 43 and 51 mW/cm² respectively.

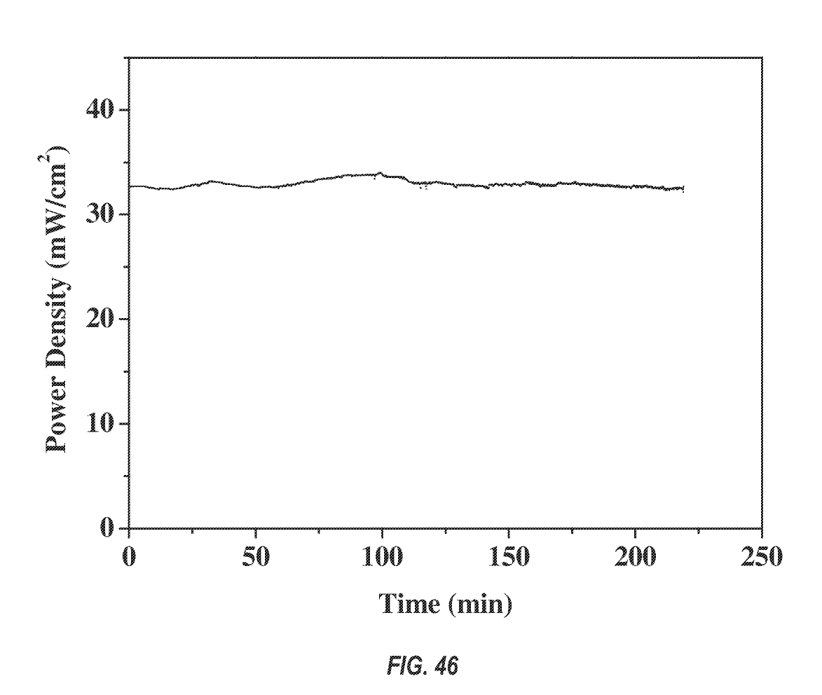

The continuous operation of a starch fueled cell was also conducted under constant discharge current of 160 mA/cm², as shown in FIG. 46. The starch-POM-I solution was pre-heated to 80° C. to ensure thermal reduction of POM-I before the discharge test. For the cathode, POM-II was oxidatively regenerated by mixing with oxygen in the cathode tank (details are given in supplementary information). The cell worked continuously for about 4 hours under 80° C. and the power density was stabilized at c.a. 32 mW/cm² (FIG. 46), which suggests both POM-I and

POM-II are regenerable under this experimental condition, and the biomass fuel cell can continuously provide electricity by directly consuming starch.

### Experiment

As shown in FIG. 40, with glucose-POM-I system held in the anode tank at 100° C., the reduction degree kept increasing. Correspondingly, the power density of the fuel cell output was raised from 9.5 to 45 mW/cm² with the increase of POM-I reduction degree from 0.31 to 1.18 mole electron/mole POM after 90 min.

### Ascorbic Acid Experiment

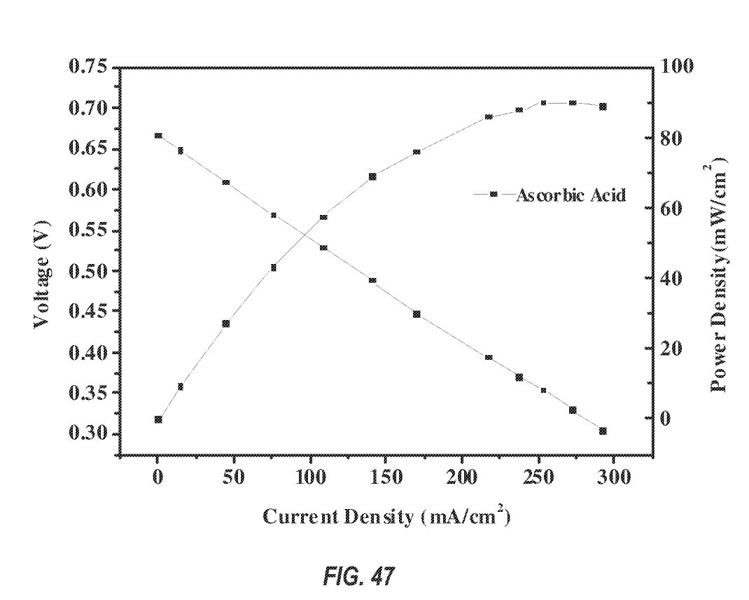

The ascorbic acid was used as fuel with extremely low concentration, about 1 mg/mL. The ascorbic solution was mixed with 0.3 mol/L POM-I in anode fuel cell tank, After preheating ascorbic acid at 80° C. for half hour, the reduction degree of POM-I reached 1.6. The performance of ascorbic fuel cell was measured under the condition that the anode side was pumped with obtained ascorbic-POM-I solution; and cathode side was pumped with 0.3 mol/L POM-II with the flow rate 15 mL/min in both anode and cathode side. The power density of ascorbic acid fueled cell was as high as 90 mW/cm² (FIG. 47).

### Experimental Results

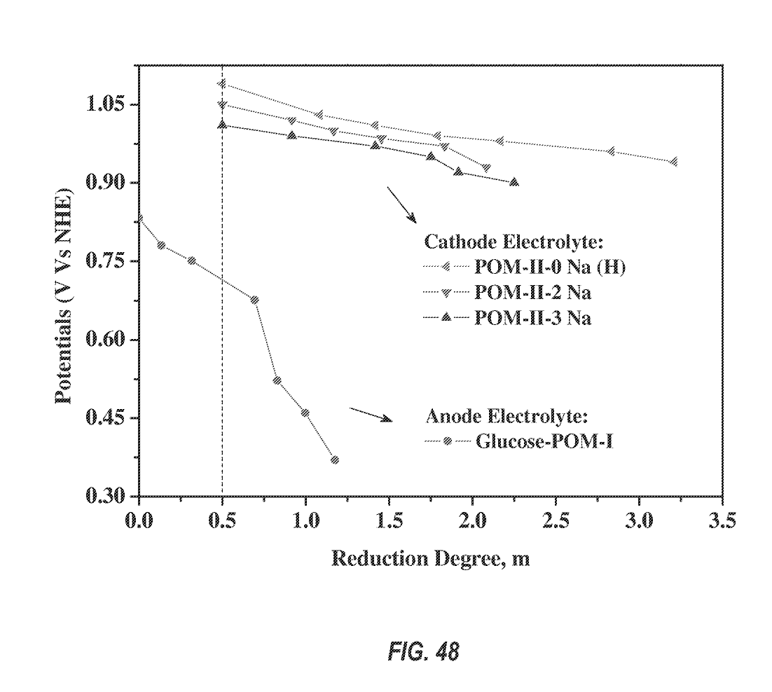

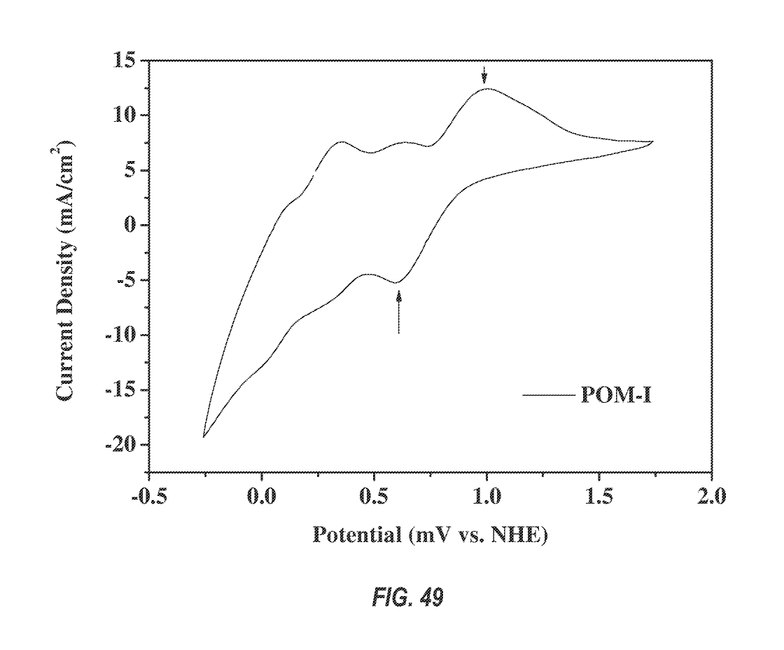

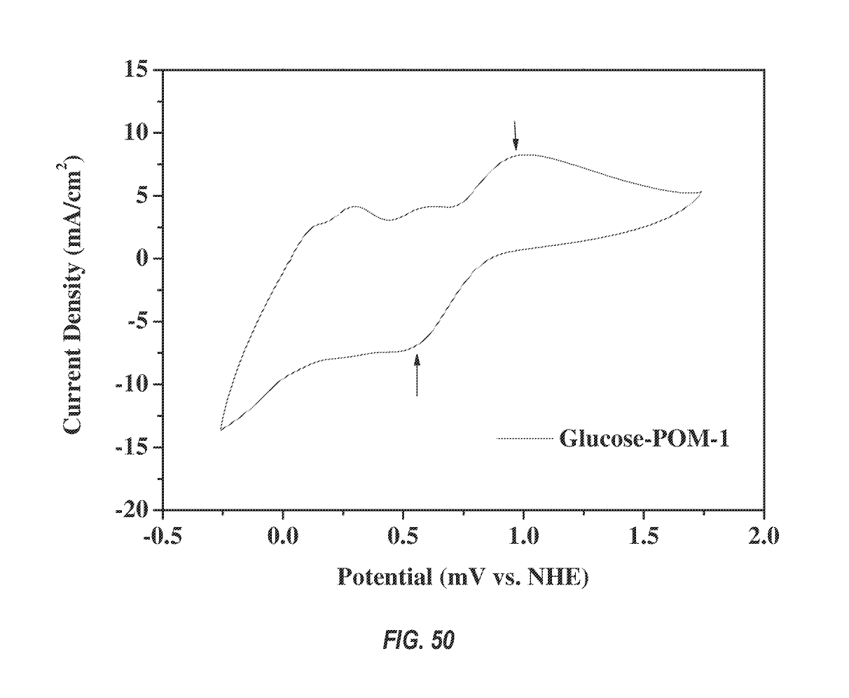

The redox potential of POM-I solution and the entire fuel cell performance are closely related to the reduction degree of POM-I. During the redox reaction of POM-I and glucose, the formal redox potential of POM-I was determined by connecting the graphite working electrode with an Ag/AgCl reference electrode. As shown in FIG. 48, fast redox potential drops were observed with the increase of the reaction time between POM-I and glucose (anode electrolyte). Specifically, redox potentials drop from 0.8 V (vs. NHE, on graphite) to 0.35 V with the reduction degree increasing from 0 to 1.2. Cyclic volammograms were taken both of the initial, POM-I solution, and a starch-POM-I solution (2 mol/L starch, 0.3 mol/L POM-I) on a graphite electrode with a scan rate of 10 mV/s at room temperature, the results of which are shown in FIG. 49, and FIG. 50.

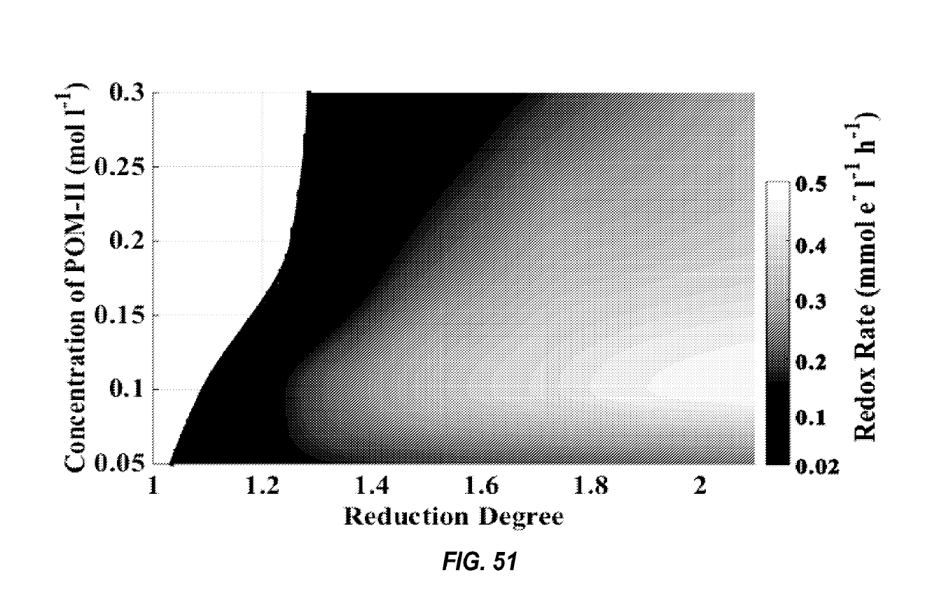

For the cathode electrolyte, POM-II had a high initial redox potential value of E (1.09 V vs. NHE, on graphite), which is shown in FIG. 48. A graphical depiction of reduction degree as a function of POM-II concentration is shown in FIG. 51. Unlike the anode electrolyte POM-I, the formal redox potential of POM-II showed only a small drop when the reduction degree of POM-II was increased. The slow decrease of the reduction degree of POM-II is because this POM composes 7 vanadium elements that act as “vanadium reservoir” to maintain a relatively high redox potential during the discharge process. Therefore, as the reduction degree of POM-I increases, the voltage difference between anode POM-I and cathode POM-II raises as does the fuel cell power output.

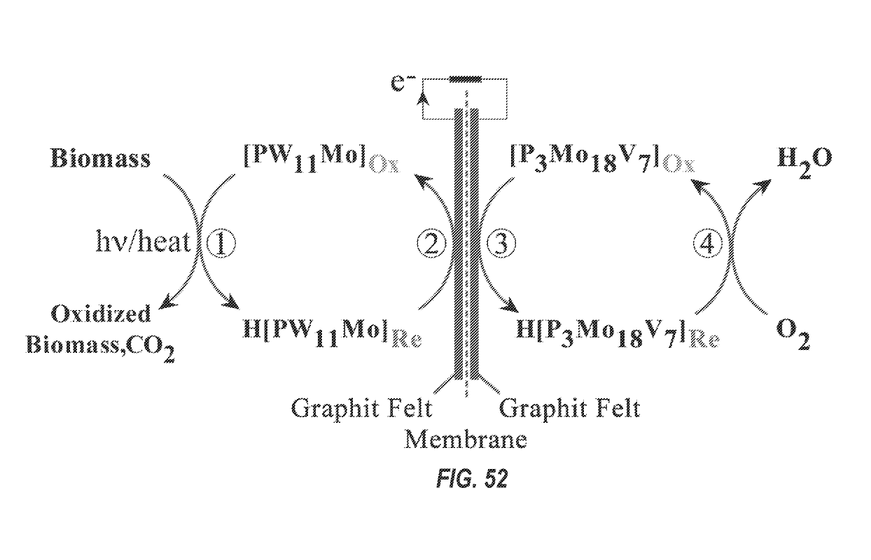

The stable performance during continuous operation of this fuel cell is closely associated with all four steps shown in FIG. 52. For example, the discharging current is up to 200 mA/cm² at the maximum point of depower density (shown in FIG. 44), which means over 1 cm² electrode, 7.46 mmol electrons were transferred from anode to cathode within one hour. This suggests that, to continuously produce 200 mA/cm² current, the biomass must transfer no less than 7.46 mmol electrons per hour to POM-I in the anode tank (step 1), and reduced POM-II must transfer no less than 7.46 mmol electrons per hour to oxygen in cathode tank (step 4) under the fuel cell conditions operated in the examples.

### Advantages

The high-performance direct biomass fuel cell disclosed in some embodiments herein can offer many advantages. For a conventional fuel cell, the noble metal catalyst can be coated on the membrane surface so the redox reaction rates on both cathode and anode are limited by the project area of membrane. On the contrary, regenerative POM solutions are used herein as catalyst and mediators to transfer the charges in biomass fuel cell so no metal electrode is needed. Furthermore, because the redox reactions occur in polyoxymetalate solutions rather than on the electrode surface, the redox reactions will not be limited by the membrane area. Practically, multiple electrodes can be placed in either anode or cathode tanks, which significantly increases the electrode surface area. In a traditional fuel cell, the O₂ molecules must diffuse through a liquid thin layer to reach the surface of catalyst, which limits the oxidation reaction rate on cathode. In our fuel cell, the redox reactions occur in solution directly so the gas-liquid-solid layer does not exist, which allows for a fast redox reaction. Lastly, H⁺ ions diffusion is directly conducted through anode and cathode liquids in our fuel cell, which does not need to diffuse through the high resistance liquid-solid-gas interface.

The direct biomass fuel cells herein incorporates the photo-catalysis and thermal degradation of biomass in a single process. In fact, most biomass fuels, mineral fuels, even some artificial polymers and organic wastes can be directly degraded by this POM to provide electricity at a low temperature (80˜100° C.). The adoption of POM completely solves the catalyst-poisoning problem because POMs are robust and self-healing. As a result, the fuels used in the direct biomass fuel cell do not require pre-purification treatment, which would significantly reduce the fuel cost. In essence, this direct biomass fuel cell can be a hybrid of fuel cell and redox flow battery, which combines the advantages of both.

In summary, the present disclosure has demonstrated (in some embodiments) a new non-noble metal fuel cell that can directly consume natural biomass at low temperature and can provide a large power-density close to the typical alcohol fuel cells. The principle of using, for instance, a POM liquid and carbon as the cathode can also be applied to other PEMFC systems to improve the output power density and reduce the fuel cell cost. Therefore, the POM direct biomass fuel cells disclosed in some embodiments herein can represent a new pathway for biomass energy conversion.

The compositions and methods of the appended claims are not limited in scope by the specific compositions and methods described herein, which are intended as illustrations of a few aspects of the claims and any compositions and methods that are functionally equivalent are intended to fall within the scope of the claims. Various modifications of the compositions and methods in addition to those shown and described herein are intended to fall within the scope of the appended claims. In particular, the presently disclosed subject matter is described in the context of fuel cells. The present disclosure, however, is not so limited, and can be applicable in other contexts. For example and not limitation, some embodiments may improve biomass processing techniques. Further, while only certain representative compositions and method steps disclosed herein are specifically described, other combinations of the compositions and method steps also are intended to fall within the scope of the appended claims, even if not specifically recited. Thus, a combination of steps, elements, components, or constituents may be explicitly mentioned herein or less, however, other combinations of steps, elements, components, and constituents are included, even though not explicitly stated. The term “comprising” and variations thereof as used herein is used synonymously with the term “including” and variations thereof and are open, non-limiting terms. Although the terms “comprising” and “including” have been used herein to describe various embodiments, the terms “consisting essentially of” and “consisting of” can be used in place of “comprising” and “including” to provide for more specific embodiments of the invention and are also disclosed. Other than in the examples, or where otherwise noted, all numbers expressing quantities of ingredients, reaction conditions, and so forth used in the specification and claims are to be understood at the very least, and not as an attempt to limit the application of the doctrine of equivalents to the scope of the claims, to be construed in light of the number of significant digits and ordinary rounding approaches.

1-122. (canceled)

123. A fuel cell comprising:
a fuel comprising an anode-side composition comprising biomass, a first polyoxometalate, water, and a reaction product of the biomass and the first polyoxometalate;
an anode electrode in fluid communication with the fuel;
a proton exchange membrane, having a first side and a second side, the first side communication with the anode electrode;
a cathode electrode in communication with the second side of the proton exchange membrane; and
a load circuit in electrical communication with the anode electrode and cathode electrode.

124. The fuel cell of claim 123, wherein the first polyoxometalate is selected from the group consisting of phosphomolybdic acid (PMo₁₂O₄₀), phosphotungistic acid (PW₁₂O₄₀), vanadium-substituted phosphomolybdic acid (PMo₉V₃O₄₀), addenda keggin type polyoxometalate (H₃PW₁₁MoO₄₀), and mixtures thereof.

125. The fuel cell of claim 123, wherein the anode-side composition further comprises a contaminant comprising a metal ion, an inorganic nonmetal species or organic containing the element Nitrogen, Sulfur, Phosphorus, or a combination thereof.

126. The fuel cell of claim 123, wherein a portion of the fuel in fluid communication with the anode electrode is at a temperature of 22° C. to 150° C.

127. The fuel cell of claim 123, wherein the anode electrode, the cathode electrode, or both do not comprise a surface catalyst.

128. The fuel cell of claim 123, further comprising:
an oxidizer solution comprising a cathode-side composition in fluid communication with the cathode electrode;
an oxidizer gas mixing tank in fluid communication with the oxidizer solution, and adapted to receive an oxidizer gas,
wherein the cathode-side composition comprises a second polyoxometalate and water.

129. The fuel cell of claim 128, wherein the second polyoxometalate is selected from the group consisting of phosphomolybdic acid (PMo₁₂O₄₀), phosphotungistic acid (PW₁₂O₄₀), vanadium-substituted phosphomolybdic acid (PMo₉V₃O₄₀), addenda keggin type polyoxometalate (H₃PW₁₁MoO₄₀), and mixtures thereof.

130. The fuel cell of claim 128,
wherein the cathode-side composition further comprises a neutralizer selected from the group consisting of alkali metals, alkali earth elements, transition metal cations, organic cations, and mixtures thereof, and
the cathode-side composition further comprises a reaction product of the neutralizer and the second polyoxometalate.

131. The fuel cell of claim 130, wherein the reaction product of the neutralizer and the second polyoxometalate comprises a salt-substituted oxidizer.

132. The fuel cell of claim 128, wherein the second polyoxometalate can be regenerated by oxygen gas.

133. The fuel cell of claim 128, wherein the anode-side composition further comprises a contaminant comprising a metal ion, an inorganic nonmetal species or organic containing the element Nitrogen, Sulfur, Phosphorus, or a combination thereof.

134. The fuel cell of claim 128, wherein the anode electrode, the cathode electrode, or both do not comprise a surface catalyst.

135. The fuel cell of claim 129,
wherein the cathode-side composition further comprises a neutralizer selected from the group consisting of alkali metals, alkali earth elements, transition metal cations, organic cations, and mixtures thereof;
wherein the cathode-side composition further comprises a reaction product of the neutralizer and the second polyoxometalate;
wherein the anode-side composition further comprises a contaminant comprising a metal ion, an inorganic nonmetal species or organic containing the element Nitrogen, Sulfur, Phosphorus, or a combination thereof; and
wherein the anode electrode, the cathode electrode, or both do not comprise a surface catalyst.

136. A method, comprising:
reducing a fuel comprising biomass, a first polyoxometalate, and water;
pumping the fuel through a flow plate in communication with an anode electrode of a fuel cell comprising the anode electrode, a proton exchange membrane having a first and a second side, the first side in communication with the anode electrode, and the second side in communication with a cathode electrode, and a load circuit;
pumping an oxidizer through a flow plate in communication with the cathode electrode of a fuel cell;
connecting a load to the load circuit.

137. The method of claim 136, wherein the first polyoxometalate is selected from the group consisting of phosphomolybdic acid (PMo₁₂O₄₀), phosphotungistic acid (PW₁₂O₄₀), vanadium-substituted phosphomolybdic acid (PMo₉V₃O₄₀), addenda keggin type polyoxometalate (H₃PW₁₁MoO₄₀), and mixtures thereof.

138. The method of claim 136, wherein reducing the fuel comprises heating the fuel to a temperature of 22° C. to 350° C., illuminating the fuel with a light source, or both.

139. The method of claim 138, wherein the light source provides light comprising a wavelength of 700 nm to 1000 nm.

140. The method of claim 136, wherein the oxidizer is a gas comprising oxygen.

141. The method of claim 136,
wherein the oxidizer is a solution comprising a second polyoxometalate and water, and
further comprising the steps of:
pumping the oxidizer through a gas mixing tank; and
pumping an oxidizing gas through the gas mixing tank.

142. The method of claim 136, wherein the fuel is pumped through the flow plate in communication with the anode electrode at a temperature of 22° C. to 150° C.
